(19) United States
(12) Patent Application Publication
(10) Pub. No.: US 2005/0000755 A1
(43) Pub. Date: Jan. 6, 2005

(54) Brake operating apparatus

(75) Inventors: Hiroshi Ikegami, Tokyo (JP); Hiroyasu Ishikawa, Tokyo (JP); Minoru Mashiko, Tokyo (JP); Hitoshi Furukawa, Tokyo (JP); Yukimasa Mitsude, Tokyo (JP); Shinichi Terashima, Tokyo (JP)

Correspondence Address: MORGAN LEWIS & BOCKIUS LLP, 1111 PENNSYLVANIA AVENUE NW, WASHINGTON, DC, 20004, US

(73) Assignee: AKEBONO BRAKE INDUSTRY CO., LTD.

(21) Appl. No.: 10/809,810

(22) Filed: Mar. 26, 2004

(30) Foreign Application Priority Data
Mar. 27, 2003 (JP) P.2003-087384
Dec. 26, 2003 (JP) P.2003-433369
Dec. 26, 2003 (JP) P.2003-433370

(51) Int. Cl. B62L 5/00

(52) U.S. Cl. 188/26

(57) ABSTRACT

An operating apparatus 1100 of a brake apparatus 1001 for restricting rotation of a brake drum 1003 including an operating lever 1112 and an operation restricting portion 1120 is provided. The operating lever 1112 is supported to be able to operate in a movable range. The movable range includes: a brake release mode permitting rotation of the brake drum 1003 both in regular rotation and reverse rotation; and an auxiliary brake mode restricting only reverse rotation of the brake drum. The operating lever 1112 is urged in a direction reaching the auxiliary brake mode from the brake release mode in a normal state. The operation restricting portion 1120 restricts a movement of the operating lever 1112 reaching the auxiliary brake mode by being brought into contact with the operating lever 1112 in the brake release mode.

### BACKGROUND OF THE INVENTION

The present invention relates to a brake apparatus, further in details, relates to a brake operating apparatus of a brake apparatus preferably used in a vehicle of a wheelchair or the like, an industrial machine or the like.

As a brake apparatus of this kind, for example, there is known a drum brake apparatus for a wheelchair shown in JP-A-2002-078751.

The brake apparatus for a wheelchair described in JP-A-2002-078751 is provided with a brake apparatus constituted by a bidirectional rotary clutch mechanism at an axle thereof and the clutch mechanism provided at inside of the brake apparatus can be operated to switch by operating a separately provided operating lever.

Further in details, the operating lever can be switched to a forward running position for operating the clutch mechanism to permit a wheel to rotate only regularly, a rearward running position for operating the clutch mechanism to permit the wheel to rotate only reversely, and a parking position for restricting both regular and reverse rotation and when the operating lever is operated to the forward running position, only forward running can be carried out. Further, when the operating lever is operated to the rearward running position, only rearward running can be carried out. Further, when the operating lever is switched to the parking position, running is restricted in both forward and rearward movement.

For a brake apparatus which can be switched to a plurality of operating states as in the above-described brake apparatus, a complicated operating apparatus is needed.

Further, in the above-described brake apparatus, a bracket having guide grooves provided in correspondence with the respective operating states at respective positions thereof is fixed to a frame of a wheelchair, further, by engaging a shaft portion of an operating lever connected to a link arm extended from the brake apparatus to fix to a desired guide groove, the operating lever can be switched to respective operating states and held at the respective operating states.

Meanwhile, according to intensive researches by the inventors, various points to be improved have been found with regard to the above-described operating apparatus of the prior art.

First, according to the operating apparatus of the prior art, by engaging the operating lever to the guide grooves, the operating lever can be switched to the respective operating states and held at the respective operating states. Therefore, when a stroke amount (movable range) of the operating lever is changed, shapes and dimensions of the guide grooves need to newly redesign at each time thereof.

Further, although the guide grooves (brackets) and the operating lever are parts of the same brake apparatus, the guide grooves and the operating lever are integrated to the wheelchair by respective separate fabricating steps. Further, the bracket is attached in fabricating a frame of the wheelchair and on the other hand, the operating lever is integrated in operation of integrating the wheel and the brake apparatus to the frame.

Therefore, compatibility in adjusting positions among the respective parts are difficult to achieve and depending on cases, a phenomenon of jumping (rattling) the operating lever at insides of the guide grooves is brought about.

Further, another example of a brake apparatus for a wheelchair of this kind is disclosed in JP-A-07-227408.

The brake apparatus for a wheelchair described in JP-A-07-227408 is constituted by including a lock member operated to a surface (tread) of a wheel by being brought into contact therewith, an operating lever for pivoting the lock member, a link mechanism for changing a contact angle of the lock member relative to the wheel in accordance with a pivoting angle of the operating lever, and a tension spring for urging the operating lever to a neutral position in a normal state.

Further, according to the operating lever, the neutral position is constituted by a free position at which the brake is released in both of forward movement and rearward movement of a wheelchair, when the operating lever is pulled from the neutral position to a rear side of the wheelchair, the neutral position is switched to a lock position, further, when the operating lever is brought down from the neutral position to a front side of the wheelchair, the neutral position is switched to a reverse rotation preventing position.

Further, in switching to the lock position, the lock member is pressed to the wheel to hamper regular rotation and reverse rotation of the wheel and therefore, the brake apparatus functions as a parking brake.

Further, in switching to the reverse rotation preventing position, in accordance with reverse rotation of the wheel, the lock member is made to wrap on the wheel to lock to thereby hamper reverse rotation of the wheel and therefore, the wheelchair is permitted to run only in forward movement. Therefore, in switching to the reverse rotation preventing position, the brake apparatus functions as a sloping path brake.

Meanwhile, according to intensive researches by the inventors, various points to be improved have been found with regard to the above-described brake apparatus of the prior art.

First, according to the brake apparatus of the prior art, the operating lever is always urged from the reverse rotation preventing position to the fee position by the tension of the tension spring.

Therefore, when in running on a sloping path, excessive impact is applied to the wheel or a vehicle body, as well as when in running on a sloping path, the arm of a boarding person extended to the wheel interferes with the operating lever, the operating lever returns to the free position (neutral position) against intention of the boarding person and there is a concern that the brake is released although the wheelchair is running on the sloping path.

Further, according to the above-described brake apparatus, in setting the neutral position of the operating lever, it is necessary to design a length of a link integrated to a link mechanism to a pertinent length in consideration of the tension of the tension spring. Therefore, a degree of freedom in view of design is deficient and even in a slight change in the specification, a link ratio or the like needs to recalculate, which is devoid of general purpose performance. Further, also a number of parts is large and there is room in improvement also in view of fabricating cost.

Furthermore, as another example of an operating apparatus of a brake apparatus, there is known a parking brake mechanism of a walking assistor shown in JP-A-2001-247021.

The parking brake mechanism described in JP-A-2001-247021 is provided with a base frame (bracket) of a support piece integrated type fixed to a grip pipe via a support piece (clamp) pinching the grip pipe, an operating lever rotatably connected centering on a pivoting shaft provided at the base frame, and a wire connected to the operating lever.

Further, an end portion of the wire is connected to a brake unit provided at a wheel and when the operating lever is gripped to a side of the grip pipe by constituting a fulcrum by the grip pipe, the wire is applied with a tension and brake is devised to apply.

Meanwhile, according to intensive researches by the inventors, there have been found various points to be improved with regard to the above-described parking brake mechanism or the like of the prior art.

First, the brake operating apparatus of the prior art is fixed to a vehicle by using, for example, a clamp or the like and therefore, in operating the operating lever, a large reaction force is concentrically operated to one point of the clamp in accordance with the operation.

Therefore, a solid material of an iron plate, an aluminum diecast product or the like is obliged to select for the clamp and in order to promote a beautiful outlook thereof, there is needed a measure of separately fabricating a resin cover or the like for covering the clamp, or coating the clamp.

Further, according to the brake operating apparatus of the prior art, the reaction force in operation is received by one point of the clamp and therefore, in fixing the brake operating apparatus, the clamp needs to tightly fasten to the grip pipe by using a bolt or the like. Further, an operator needs to adjust an angle and a position of fixing the clamp for each vehicle and in this way, according to the brake operating apparatus of the prior art, much time and labor is taken in integrating the brake operating apparatus and when fabricating cost or the like is taken into account, there is yet much room for improvement.

### SUMMARY OF THE INVENTION

The invention has been carried out in consideration of such technical backgrounds. It is an object of the present invention to provide an operating apparatus of a brake apparatus rich in general purpose performance and capable of further firmly positioning an operating lever.

Further, it is another object of the present invention to provide a brake operating apparatus capable of being fabricated inexpensively and rich in handiness.

Moreover, it is another object of the present invention to provide a brake operating apparatus facilitated to integrate to a vehicle and capable of pertinently selecting to use a resin material or the like rich in color. Further, it is an object of the present invention to provide a method of attaching the same.

The objects can be achieved by an operating apparatus of a brake apparatus for restricting rotation of a rotating member according to the present invention, comprising: an operating lever supported to be able to operate in a movable range including a first position permitting the rotating member to rotate regularly and rotate reversely and a second position restricting only either one of regular rotation and reverse rotation of the rotating member and urged from the first position to the second position in a normal state; and an operation restricting portion brought into contact with the operating lever at the first position for restricting movement of the operating lever reaching the second position.

The invention constituted as described above is provided with the operating lever capable of being operated in the movable range including the first position permitting regular rotation and reverse rotation of the rotating member, and the second position restricting only either one of regular rotation and reverse rotation of the rotating member. Further, the operating lever is urged from the first position to the second position in the normal state.

Further, the invention is provided with the operation restricting portion for restricting movement of the operating lever reaching the second position by being brought into contact with the operating lever at the first position.

Therefore, the operating lever is brought into a state of being brought into contact with the operation restricting portion by an external force in accordance with the urging and is positioned at the first position by the contact state.

That is, there is brought about a state in which the external force in accordance with the urging and a reactive force reacted against the external force are operated to the operating lever and the operating lever is positioned by a balance between the two forces. Therefore, the operating lever can be positioned more firmly than in positioning depending on engagement. Further, also guide grooves required for engagement are not needed and various specifications can easily be dealt with by changing a contact portion or the like.

Further, there may be constructed a constitution further comprising a supporting member for operably supporting the operating lever, wherein the supporting member comprises a contact member capable of being brought into contact with the operating lever and urging member for urging the contact member to the operating lever, and the operating lever comprises an operation restricting member for restricting movement of the operating lever reaching the second position by being brought into contact with the contact member at the first position.

According to the constitution, the operating lever is connected to and supported by the supporting member, further, the supporting member is provided with the urging member for urging the contact member and urging member for urging the contact member to the operating lever as the position restricting portion. Further, a side of the operating lever is provided with the operation restricting member brought into contact with the contact member in operating to the first position and the operating lever is positioned by the contact state of the contact member and the operation restricting member.

Further, there may be constructed a constitution in which a third position restricting both of regular rotation and reverse rotation of the rotating member is provided at a position different from the second position and the operating lever is urged in a direction reaching the second position from the third position by way of the first position in the normal state.

According to the constitution, the third position for restricting rotation of the rotating member is set at the position different from the second position and when the operating lever is operated to the third position, the rotation of the rotating member is restricted. Further, the operating lever is urged in the direction reaching the second position from the third position by way of the first position in the normal state and therefore, simultaneously with reaching the first position, the contact state is produced at the operation restricting portion and movement of the operating lever is restricted at the first position. Therefore, the operator can operate the operating lever between the third position and the first position without being conscious of operation to the second position.

Further, there may be constructed a constitution in which the brake apparatus comprises a main brake member for restricting regular rotation and reverse rotation of the rotating member, an auxiliary brake member for restricting reverse rotation of the rotating member by being self-locked by being brought into contact with the rotating member in reversely rotating the rotating member, and an operating cam for individually operating the main brake member and the auxiliary brake member by following an operation to the operating lever, wherein in operating the operating lever from the first position to the third position, the operating can is operated to press the main brake member to the rotating member by a press force in accordance with an operating amount thereof and when the operating lever is operated to the second position, the operating cam is operated to bring only the auxiliary brake member into contact with the rotating member.

That is, when the operating lever is operated from the first position to the third position, the main brake member is pressed to the rotating member by the press force in accordance with the operating force at each time thereof. Further, regular rotation and reverse rotation of the rotating member are restricted by the brake force produced by the main brake member. Further, when the operating lever is operated to the second position, the auxiliary brake member is brought into contact with the rotating member and only reverse rotation of the rotating member is restricted by the brake force produced by the auxiliary brake member.

Further, there may be constructed a constitution further comprising a one way clutch apparatus for permitting to only operate the operating lever from the first position to the third position, and a release apparatus for releasing an operation by the one way clutch from being restricted.

According to the constitution, there is provided the one way clutch apparatus for permitting only to operate the operating lever operated from the first position to the third position. Therefore, when the operating lever is operated to the third position, thereafter, the operating lever is held at a position in accordance with an operating amount thereof. Therefore, the brake force in accordance with the operating amount is maintained without operating the operating lever. Further, in operating the release apparatus, the operating lever can be operated in a desired direction and therefore, the brake force can be weakened or strengthened by operating the operating lever.

Further, as the one way clutch apparatus, a one way mesh type clutch, a ratchet apparatus or the like can be exemplified as an example thereof.

Further, the present invention also provides an operating apparatus of a brake apparatus, for restricting rotation of a rotating member, comprising: an operating lever for operating a brake force in accordance with an operating amount thereof to the rotating member when the operating lever is operated in a predetermined direction; a one way clutch apparatus for permitting only to operate the operating lever operated in the predetermined direction and holding the operating lever at a position in accordance with the operating amount; a release apparatus for releasing an operation of the operating lever by the one way clutch apparatus from being restricted; and an operating portion for operating the release apparatus provided at an arm extended to a position capable of being gripped along with the operating lever in operating the operating lever to operate in the predetermined direction.

The invention constituted in this way is provided with the one way clutch apparatus permitted to operate only in the predetermined direction exerting the brake force. Therefore, in operating to the predetermined direction, the operating lever is held at the position in accordance with the operating amount, thereafter, the brake force in accordance with the operating amount is maintained without operating the operating lever.

Further, there is provided the release apparatus for releasing the operation of the operating lever from being restricted and the operating portion of the release apparatus is provided at the arm which can be gripped by the one hand along with the operating lever. That is, the release apparatus can be operated while gripping the operating lever and therefore, the operator can release the operation of the operating lever from being restricted while maintaining the brake force.

Further, there may be constructed a constitution in which the operating portion provided at the arm is provided to be able to operate in a peripheral direction of the arm.

According to the constitution, the operating portion is provided to be able to operate in the peripheral direction of the arm. Therefore, even in operating the operating lever while pulling the operating lever to the side of the arm, the operating portion can be operated easily by the thumb or the like without relaxing the force exerted to the operating lever.

Moreover, the present invention is also provides a brake operating apparatus comprising a first and a second operating lever for operating a brake apparatus for individually restricting rotation of a rotating member, in which the first and the second operating levers are supported to be able to operate in a movable range including a first position permitting regular rotation and reverse rotation of the rotating member, a second position restricting only either one of regular rotation and reverse rotation of the rotating member, and a third position restricting both of regular rotation and reverse rotation of the rotating member, and the operating levers are urged in a direction reaching the second position in a normal state.

The brake operating apparatus of the invention constituted as described above is provided with the first and the second operating levers for individually operating the brake apparatus. Further, the first and the second operating levers are supported to be able to operate in the movable range including the first position permitting both of regular rotation and reverse rotation of the rotating member, the second position restricting either one of regular rotation and reverse rotation of the rotating member, and the third position restricting both of regular rotation and reverse rotation of the rotating member.

Further, it is more preferable that the first and the second operating levers are respectively urged in the direction reaching the second position in the normal state.

That is, according to the invention, in the first and the second operating levers capable of being switched to the first position and the second position as well as the third position, the urging direction is determined such that the first and the second operating levers finally reach the second position.

Therefore, for example, when the first or the second operating lever is operated against intention of an operator, the operating lever reaches the second position by an external force in accordance with the urging, as a result, rotation of the rotating member is restricted.

Further, in the above-described, the “reaching direction” determines the direction and the final point, and the start point may be at anywhere such that, for example, the operating lever is operated from the first position to the second position, as a result, reaches the second position, and reaches the second position from the third position by way of the first position.

Further, there may be constructed a constitution in which the first and the second operating levers respectively constitute a start point by the third position and are urged in a direction reaching the second position from the third position by way of the first position, further comprising: an operation restricting portion for restricting an operation of the operating lever reaching the second position from the third position at the first position by being brought into contact with the operating lever at the first position.

According to the constitution, the start point is constituted by the third position and the operating lever is urged in the direction of reaching the second position from the start point by way of the first position. Further, there is provided the operation restricting portion for restricting the operation of the operating lever reaching the second position from the third position by the first position by being brought into contact with the operating lever at the first position.

That is, the operation of the operating lever reaching the second position from the third position by way of the first position in accordance with the urging is restricted by the first position by the contact state at the operation restricting portion.

Therefore, when the operating lever is set free at the third position, the operating lever is stopped at the first position without reaching the second position. Therefore, in switching to the third position and the first position, the operating lever can be operated without being conscious of erroneous operation to the second position.

Further, there may be constructed a constitution further comprising a main brake member for restricting regular rotation and reverse rotation of the rotating member, an auxiliary braking member for restricting reverse rotation of the rotating member by being self-locked by being engaged with the rotating member in reverse rotation of the rotating member, and a cam for individually operating the main brake member and the auxiliary brake member by following an operation to the first or the second operating lever, and in operating the first or the second operating lever directed from the first position to the third position, the cam is operated such that the main brake member is pressed to the rotating member by a press force in accordance with an operating amount thereof, and when the first or the second operating lever is operated to the second position, the cam is operated such that only the auxiliary brake member is brought into contact with the rotating member.

That is, when the first or the second operating lever is operated from the first position to the third position, the main brake member is pressed to the rotating member by the press force in accordance with an operating force at each time thereof. Therefore, regular rotation and reverse rotation of the rotating member are restricted by the brake force produced by the main brake member.

Further, when the first or the second operating lever is operated to the second position, the auxiliary brake member is self-locked by being brought into contact with the rotating member and only reverse rotation of the rotating member is restricted by the brake force produced by the auxiliary brake member.

Further, there may be constructed a constitution further comprising a one way clutch apparatus permitting only an operation of the first or the second operating lever directed from the first position to the third position, and a release apparatus for releasing the operation of the one way clutch apparatus from being restricted.

According to the constitution, there is provided the one way clutch apparatus for permitting only operation of the first or the second operating lever directed from the first position to the third position. Therefore, when the first or the second operating lever is operated to the third position, thereafter, the first or the second operating lever is maintained at a position in accordance with an operating amount thereof. Therefore, thereafter, the brake force in accordance with the operating amount is maintained without operating the operating lever. Further, in operating the release apparatus, the operating lever can be operated in a desired direction and therefore, the brake force can arbitrarily be adjusted.

Further, as the one way clutch apparatus, a one way mesh type clutch, or a ratchet apparatus or the like can be exemplified as an example thereof.

Further, it is more preferable that the brake operating apparatus further comprises: a connecting member for connecting the brake apparatus and the first and the second operating levers and transmitting an operation to the first and the second operating levers to the brake apparatus, wherein the connecting member comprises a first connecting member extended from the brake apparatus and a second connecting member connecting the first connecting member to the first and the second operating levers, and a pulling amount adjusting apparatus between the first connecting member and the second connecting member for making the second connecting member remote from the first connecting member in operating a predetermined load to the second connecting member.

According to the constitution, there are provided the first connecting member extended from the brake apparatus and the second connecting apparatus for connecting the first connecting member to the first or the second operating lever. Further, the pulling amount adjusting apparatus is provided between the first connecting member and the second connecting member. When the predetermined load is operated to the second connecting member, the pulling amount adjusting apparatus is operated in a direction of making the second connecting member remote from the first connecting member. Therefore, an operating amount (movable amount) thereof is added to a pulling amount (stroke) of the first or the second operating lever and therefore, in operating the pulling amount adjusting apparatus, the pulling amount of the operating lever can be ensured to be large.

Moreover, the present invention also provides a brake operating apparatus including an operating lever for operating a brake apparatus provided at a vehicle, and a supporting member for pivotably supporting the operating lever, in which the operating lever is provided to the vehicle via the supporting member; wherein the supporting member comprises: a ring-like connecting portion outwardly fit to a first frame extended in a predetermined direction of the vehicle; and a pivoting movement restricting portion brought into contact with a second frame extended in a direction different from a direction of the first frame for restricting pivoting movement of the supporting member around an axis of the first frame.

The brake operating apparatus constituted in this way includes the operating lever and the supporting member and the supporting member is fixed to the first frame extended in the predetermined direction of the vehicle and the second frame extended in the direction different from the direction of the first frame.

Further, the support member is provided with the ring-like connecting portion outwardly fit to the first frame and the contact portion brought in contact with the second frame and in fixing to the vehicle, a connected state between the supporting member and the first frame is established by the ring-like connecting portion. Further, pivoting movement (positional shift) of the supporting member around the axis of the first frame is restricted by the contact portion brought into a state of being brought into contact with the second frame.

That is, the supporting member is fixed at a plurality of portions of the ring-like connecting portion and the contact portion and therefore, a structure of fixing to the respective portions can be constituted by a simple structure. Further, in integrating the brake operating apparatus, the supporting member is positioned at the plurality of portions of the ring-like connecting portion and the contact portion and therefore, an operator can attach the supporting member to a desired position without adjusting the position of the supporting member. Further, it is not necessary to use a solid material of a metal, aluminum or the like in connecting the ring-like connecting portion and the contact portion and therefore, for example, a resin material or the like rich in color can also be selected. Further, the above-described “ring-like shape” may be of a concept including a ring-like shape of a closed type in which both ends thereof are connected to each other to close as well as a ring-like shape of an opened type in which both ends are arranged to be proximate to each other.

Further, there may be constructed a constitution in which the ring-like connecting portion includes a sleeve having an inner diameter capable of being outwardly fit to the first frame, and a pressing portion provided at an inner peripheral face of the sleeve for pressing the inner peripheral face of the sleeve to the first frame in outwardly fitting to the first frame.

According to the constitution, the sleeve capable of being outwardly fit to the first frame is used as the ring-like connecting portion. Further, the inner peripheral face of the sleeve is provided with the pressing portion for pressing the inner peripheral face of the sleeve to the first frame in outwardly fitting to the first frame.

Therefore, in outwardly fitting to the sleeve, the inner peripheral face of the sleeve is pressed to the first frame and therefore, the sleeve is fixed to the first frame owing to the pressing. Therefore, a positional shift of the sleeve in an axial direction of the first frame and rotation of the sleeve in a peripheral direction of the first frame are restrained.

Further, there may be constructed a constitution in which the pressing portion includes a bent portion provided to expand from the inner peripheral face of the sleeve, and an air gap formed on a back side of the bent portion for permitting to deform the bent portion to an outer side of the sleeve in outwardly fitting to the first frame.

According to the constitution, the bent portion expanded from the inner peripheral face of the sleeve is provided at inside of the sleeve. Further, the air gap is provided on the back side of the bent portion and in outwardly fitting to the first frame, by the air gap, the bent portion is permitted to deform to the outer side of the sleeve.

Therefore, in outwardly fitting the sleeve to the first frame, the sleeve is pertinently pressed at the bent portion, further, in integrating the sleeve, the bent portion is more or less bent to the outer side of the sleeve via the air gap and therefore, the sleeve can easily be integrated thereto.

Further, there may be constructed a constitution in which the pivoting movement restricting portion is provided with a pair of pinching pieces capable of being engaged with the second frame.

According to the constitution, the pivoting movement restricting portion is provided with the pair of pinching pieces. Further, the second frame can be locked by the pinching pieces and by engaging the pinching pieces and the second frame, a connected state at the pivoting movement restricting portion is formed. Therefore, in the pivoting movement restricting portion, pivoting of the supporting member is further firmly restricted.

Further, the first frame may be a handle extended from the second frame.

Further, according to the invention, in order to achieve the objects, the following connecting method is provided.

That is, the present invention provides an attaching method for attaching a brake operating apparatus including an operating lever for operating a brake apparatus and a supporting member pivotably supporting the operating lever to a vehicle, the attaching method comprising:
a step of providing a connecting portion constituting a ring-like shape to the supporting member and inserting the connecting portion from an end portion of a first frame extended in a predetermined direction of the vehicle; and
a step of fixing the supporting member to a second frame extended in a direction different from a direction of the first frame at a position different from a position of the connecting portion after inserting the connecting portion.

According to the method, first, the connecting portion in the ring-like shape is inserted from the end portion of the first frame and the supporting member is connected to the first frame. Successively, the position different from that of the connecting portion is fixed to the second frame extended in the direction different from the direction of the first frame. Therefore, the supporting member is positioned at least at two points and therefore, in attaching the supporting member, the operator can fix the supporting member easily without adjusting the position.

Further, there may be constructed a constitution in which the first frame is a handle extended from the second frame and after inserting the connecting portion to the first frame, a grip of the handle is inserted from the end portion of the first frame to fix the grip to the handle.

According to the method, after inserting the connecting portion to the first frame, the grip of the handle is inserted from the end portion of the first frame to fix to the handle. Therefore, the grip constitutes a stopper of the supporting member for preventing from being drawn out and movement of the connecting portion in the axial direction of the first frame is restricted by the grip.

Further, the above-described various contents can be combined as much as possible within the range not deviated from the objects and the technical thought of the invention.

As described above, according to the invention, the invention can provide the operating apparatus of the brake apparatus rich in the general purpose performance and capable of further firmly positioning the operating lever.

Furthermore, according to the invention, the brake operating apparatus capable of being fabricated inexpensively and rich in handiness and general purpose performance can be provided.

Moreover, according to the invention, the brake operating apparatus facilitated to integrate to a vehicle and capable of pertinently selecting to use a resin material or the like rich in color can be provided. Further, the method of attaching the same can be provided.

### BRIEF DESCRIPTION OF THE DRAWINGS

FIG. 1 is a side view of a wheelchair attached with a brake apparatus according to a first embodiment.

FIG. 2 is a perspective view showing a state of fixing a brake drum according to the first embodiment.

FIG. 3 is a view for explaining operating states of respective constituent parts in a main brake mode of the brake apparatus shown in the first embodiment.

FIG. 4 is a view showing a position (operating state) of an operating lever in correspondence with the main brake mode, according to the first embodiment.

FIG. 5 is a view for explaining the operating states of the respective constituent parts in a brake release mode of the brake apparatus shown in the first embodiment.

FIG. 6 is a view showing a position (operating state) of the operating lever in correspondence with the brake release mode, according to the first embodiment.

FIG. 7 is a view for explaining the operating states of the respective constituent parts in an auxiliary brake mode of the brake apparatus shown in the first embodiment.

FIG. 8 is a view showing a position (operating state) of the operating lever in correspondence with the auxiliary brake mode, according to the first embodiment.

FIG. 9 is a side view of an operating apparatus shown in the first embodiment.

FIG. 10 is a view showing the operating apparatus of the first embodiment shown from a front side of the wheelchair.

FIG. 11 is an outline constitution view showing an inner structure of the operating apparatus shown in the first embodiment.

FIG. 12 is a view switching from the brake release mode shown in FIG. 11 to the main brake mode.

FIG. 13 is a view enlarging an essential portion of a one way clutch apparatus integrated to the operating apparatus shown in the first embodiment.

FIG. 14 is a view for explaining a position of an operating portion in correspondence with a case in which the one way clutch apparatus is not operated (released), according to the first embodiment.

FIG. 15 is a view for explaining a position of the operating portion in correspondence with a case in which the one way clutch apparatus is operated, according to the first embodiment.

FIG. 16 is a view showing a state in which a pulling amount adjusting apparatus is not operated, according to the first embodiment.

FIG. 17 is a view showing the state of operating the pulling amount adjusting apparatus, according to the first embodiment.

FIG. 18 is a side view of a wheelchair attached with a brake apparatus according to a second embodiment.

FIG. 19 is a perspective view showing a state of fixing a brake drum according to the second embodiment to a wheel.

FIG. 20 is an explanatory view for explaining an operating state of respective constituent parts of the brake apparatus in correspondence with a main brake mode, according to the second embodiment.

FIG. 21 is an explanatory view for explaining an operating state of a brake operating apparatus for a helper in the main brake mode (one way clutch apparatus: when not operated), according to the second embodiment.

FIG. 22 is an explanatory view for explaining an operating state of the brake operating apparatus for a helper in the main brake mode (one way clutch apparatus: when operated).

FIG. 23 is an explanatory view for explaining an operating state of a brake operating apparatus for a boarding person in the main brake mode (one way clutch apparatus: when operated), according to the second embodiment.

FIG. 24 is an explanatory view for explaining an operating state of the brake operating apparatus for a boarding person in the main brake mode (one way clutch apparatus: when not operated), according to the second embodiment.

FIG. 25 is an explanatory view for explaining an operating state of respective constituent parts of the brake apparatus in correspondence with a brake release mode, according to the second embodiment.

FIG. 26 is an explanatory view for explaining an operating state of the brake operating apparatus for a helper in the brake release mode, according to the second embodiment.

FIG. 27 is an explanatory view for explaining an operating state of the brake operating apparatus for a boarding person in the brake release mode, according to the second embodiment.

FIG. 28 is an explanatory view for explaining an operating state of the respective constituent parts of the brake apparatus in correspondence with the brake release mode, according to the second embodiment.

FIG. 29 is an explanatory view for explaining an operating state of the brake operating apparatus for a helper in the auxiliary brake mode, according to the second embodiment.

FIG. 30 is an explanatory view for explaining an operating state of the brake operating apparatus for a boarding person in the auxiliary brake mode, according to the second embodiment.

FIG. 31 is a view showing a state in which a pulling amount adjusting apparatus is not operated, according to the second embodiment.

FIG. 32 is a view showing a state in which the pulling amount adjusting apparatus is operated, according to the second embodiment.

FIG. 33 is a view enlarging an essential portion of an operation restricting portion and the one way clutch apparatus in correspondence with the main brake mode, according to the second embodiment.

FIG. 34 is a view enlarging an essential portion of the operation restricting portion and the one way clutch apparatus in correspondence with the brake release mode, according to the second embodiment.

FIG. 35 is a view enlarging an essential portion of the operation restricting portion and the one way clutch apparatus in correspondence with the auxiliary brake node, according to the second embodiment.

FIG. 36 is a side view of a wheelchair attached with a brake operating apparatus according to a third embodiment.

FIG. 37 is a side view of the brake operating apparatus shown in the third embodiment.

FIG. 38 is a view viewing the brake operating apparatus shown in the third embodiment from a front side of a wheelchair.

FIG. 39 is a sectional view showing a section taken along a line A-A′ of FIG. 37.

FIG. 40 is a view showing a state of inserting a handle to a sleeve shown in the third embodiment.

FIG. 41 is a view showing a modified example of the brake operating apparatus shown in the third embodiment.

FIG. 42 is a view viewing the brake operating apparatus shown in FIG. 41 from the front side of the wheelchair.

FIG. 43 is a view showing a modified example of the brake operating apparatus shown in the third embodiment.

### DESCRIPTION OF THE PREFERRED EMBODIMENT

Explanations will be given of preferred embodiments of the invention in reference to the drawings as follows. According to the embodiments, an explanation will be given of examples of applying an operating apparatus of the invention to a brake apparatus for a wheelchair.

(First Embodiment)

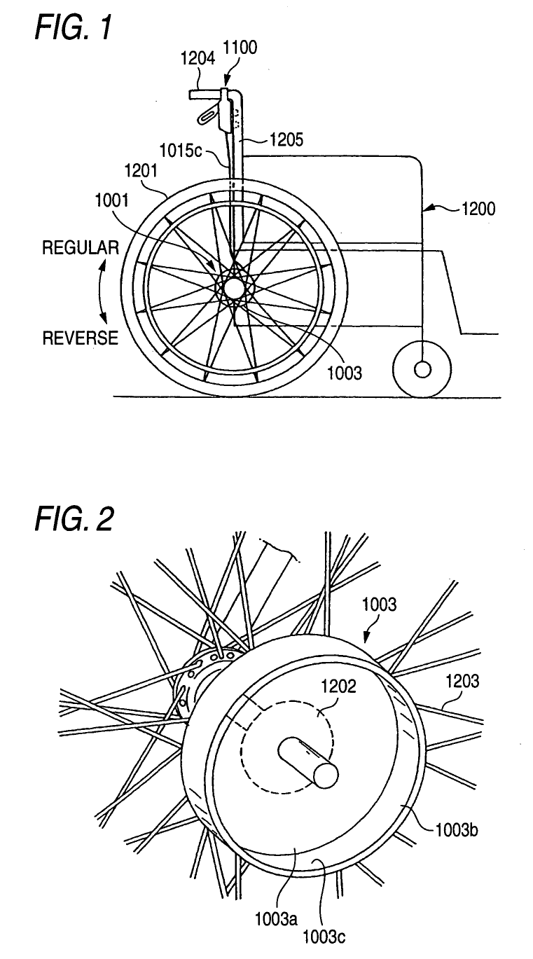

A brake apparatus 1001 shown in a first embodiment is a brake apparatus of a kind generally referred to as “inner expanding type drum brake” and is provided with a brake drum (rotating member) 1003 rotated along with a wheel 1201 as shown by FIG. 1 to FIG. 3, a main shoe 1004 (main brake member) and a lock shoe 1006 (auxiliary brake member) for producing a brake force by being brought into contact with an inner peripheral face of the brake drum 1003, and a back plate 1005 for supporting the main shoe 1004 and the lock shoe 1006 and the like at inside of the brake drum 1003.

The brake drum 1003 is fixed to a hub 1202 disposed at a rotational center of the wheel 1201 or a spoke 1203 extended radially from the hub 1202 (refer to FIG. 2).

Further in details, the brake drum 1003 is constituted by a circular base portion 1003a fixed to the hub 1202 or the spoke 1203, and a peripheral wall 1003b extended from a peripheral edge of the base portion 1003a toward a side of a frame of a wheelchair 1200 in a state of being mounted to the wheelchair 1200 and an inner peripheral face of the peripheral wall 1003b constitutes a face brought into contact with the main shoe 1004 and the lock shoe 1006.

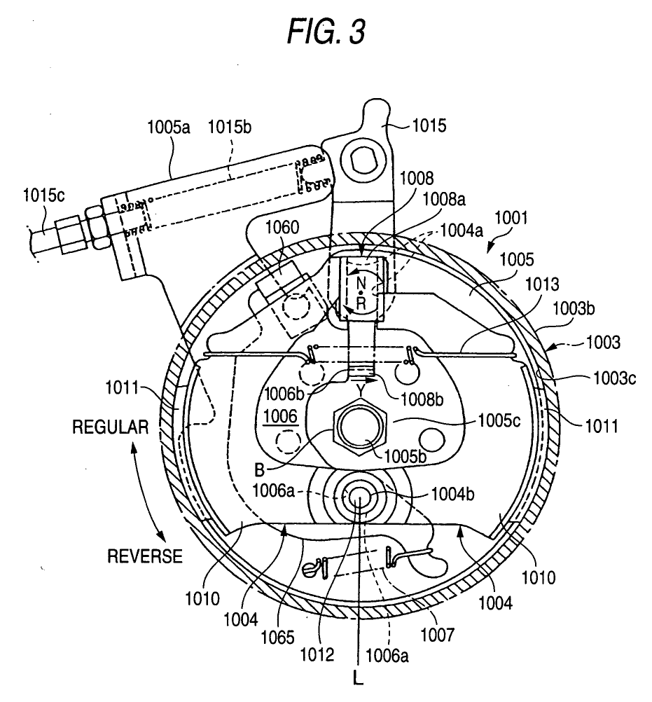

As shown by FIG. 3, the back plate 1005 is constituted by a steel plate or the like having a sufficient strength and is attached to between the frame and the wheel 1201 of the wheelchair 1200.

Further in details, an axle is inserted through an axle inserting hole 1005b formed at a center of the back plate 1005 and the back plate 1005 is fastened to fix to the axle by using a bolt 1005c or the like under the state. Further, main constituent parts constituting the brake apparatus 1001 are provided on the back plate 1005 and inside of the brake drum 1003.

As the main constituent parts constituting the brake apparatus 1001, there can be exemplified a pair of the main shoes 1004, 1004 exerting the brake force in both of regular rotation and reverse rotation of the brake drum 1003 by being brought into contact with an inner peripheral face 1003c of the brake drum 1003, a return spring 1013 for holding the respective main shoes 1004, 1004 at positions separated from the inner peripheral face 1003c of the brake drum 1003, the lock shoe 1006 for restricting only rotation in a direction of reversely rotating the brake drum by being brought into contact with the inner peripheral face 1003c of the brake drum 1003, a lock shoe return spring 1007 for holding the lock shoe 1006 at a position separated from the inner peripheral face 1003a of the brake drum 1003, and an operating cam 1008 for moving the main shoe 1004 and the lock shoe 1006 individually to positions exerting the brake force against tensions of the respective return springs 1013, 1007.

The pair of main shoes 1004, 1004 each is provided with a main shoe main body 1010 in a bow shape (arch shape) having a contact portion 1004a in contact with the operating cam 1008 at one end thereof and provided with a connecting hole 1004b for receiving an anchor pin 1012 constituting a center of pivoting the main shoes 1004 at other end thereof, and a lining 1011 constituting contact faces in contact with the main shoe main body 1010 and the brake drum inner peripheral face 1003c and fixed to the side of the main shoe main body 1010. Further, the respective main shoes 1004, 1004 are pivotably attached to the anchor pin 1012 provided on a lower side of the back plate 1005 via the connecting hole 1004b.

That is, the respective main shoes 1004, 1004 are connected to each other via the anchor pin 1012 and in accordance with pivoting the operating cam 1008, the respective main shoes 1004, 1004 are pressed to the brake drum inner peripheral face 1003c to exert the brake force by constituting force operating points by the contact portions 1004a and constituting a fulcrum by the anchor pin 1012.

Further, the respective main shoes 1004, 1004 are connected to each other by the return spring 1013 and are held at the positions separated from the inner peripheral face 1003c of the brake drum 1003 in a normal state. Further, here, the normal state is the state in which an external force in accordance with pivoting the operating cam 1008 is not operated to the main shoe 1004. Further, a detailed description will be given later of operation of the main shoe 1004.

The lock shoe 1006 is provided with a lock lining 1060 for restricting rotation of the brake drum 1003 by being self-locked by being brought into contact with the inner peripheral face 1003c of the brake drum 1003, and a lock shoe main body 1065 fixed with the lock lining 1060.

The lock shoe main body 1065 comprises a flat plate in a bow shape a total length of which is formed to be substantially longer than a shortest distance between the anchor pin 1012 and the brake drum 1003, fixed with the lock lining 1060 at one end thereof and connected with the lock shoe return spring 1007 at other end thereof.

Further, the lock shoe 1006 is provided with a connecting hole 1006a in correspondence with a connecting portion connected with the anchor pin 1012 between the one end provided with the lock lining 1060 and the other end connected with the lock shoe return spring 1007 on other end side thereof connected to the lock shoe return spring 1007. Further, the lock shoe main body 1065 is pivotably attached to the anchor pin 1012 via the connecting hole 1006a.

Further, a contact portion 1006b in contact with the operating cam 1008 is provided at a vicinity of an end portion of the lock shoe main body 1065 fixed with the lock lining 1060 and in correspondence with an angle of the operating cam 1008, the lock shoe main body 1065 is pivoted and at each time thereof, a distance between the brake drum inner peripheral face 1003c and the lock lining 1060 is changed.

Further, the lock shoe 1006 is attached to the anchor pin 1012 in a state of being offset from on a radial line L reaching the anchor pin 1012 from the brake drum 1003 in a regular rotating direction. Therefore, even when the brake drum 1003 is rotated reversely and the lock shoe 1006 and the brake drum 1003 are brought into contact with each other, the lock shoe 1006 is self-locked and a self energizing effect is produced between the lock shoe 1006 and the brake drum 1003. Therefore, reverse rotation of the brake drum 1003 is forcibly restricted by the self energizing effect. The lock shoe 1006 restricts reverse rotation of the brake drum 1003 in this way.

Further, the lock shoe 1006 is held at a position separated from the inner peripheral face 1003c of the brake drum 1003 by the tension of the lock shoe return spring 1007. Therefore, in the normal state (a state in which the brake shoe 1006 is not brought into contact with the inner peripheral face 1003c of the brake drum 1003), the self energizing effect is prevented from being brought about.

The operating cam 1008 is provided with an operating cam portion 1008a for the main shoe 1004 brought into contact with the main shoe main body 1010 at the contact portion 1004a, and an operating cam portion 1008b for the lock shoe 1006 extended further from the operating cam portion 1008a of the main shoe 1004 to an inner side in a diameter direction.

Further, the respective operating cam portions 1008a, 1008b are connected to an operating lever 1015 provided on a back side of the back plate 1005 and the operating cam portion 1008a and the operating cam portion 1008b are integrally pivoted in cooperation with the operating lever 1015.

Further, an end portion of the operating lever 1015 is provided with an operating lever return spring 1015b. The operating lever return spring 1015b is interposed between a return spring support arm 1005a extended from the back plate 1005 and the operating lever 1015 and the operating lever 1015 and is normally urged in a direction of being remote from the return spring support arm 1005a.

Further, an end portion of the operating lever 1015 is connected to an operating cable 1015c. As shown by FIG. 1, the operating cable 1015c is connected to a brake operating apparatus 1100 fixed to a handle for helper 1204 on a back side of a seat and the operating lever 1015 is devised to pivot in accordance with operation of an operating lever 1112 integrated to the brake operating apparatus 1100.

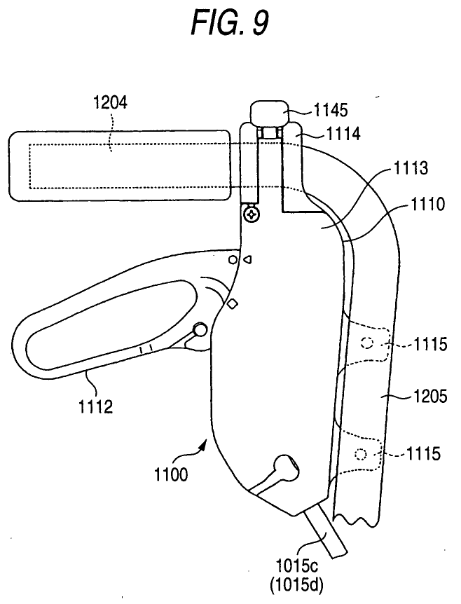

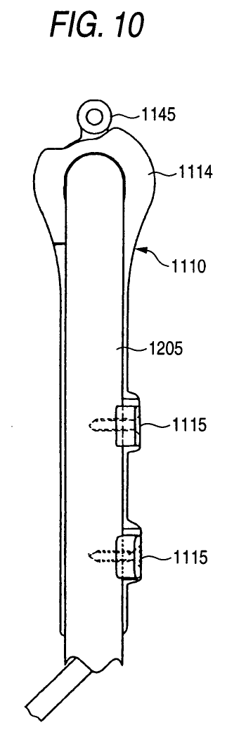

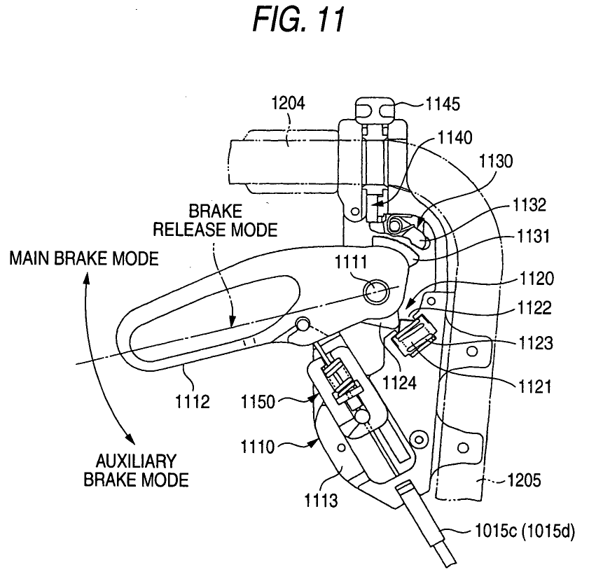

Successively, a detailed description will be given of the brake operating apparatus 1100 in reference to FIG. 9 through FIG. 12 or the like. The brake operating apparatus 100 is provided with a housing 1110 (supporting member) fixed to the handle 1204, the operating lever 1112 pivotably connected centering on a supporting shaft 1111 (refer to FIG. 11) provided at the housing 1110, an operation restricting portion 1120 for restricting operation of the operating lever 1112, a one way clutch apparatus 1130 for constraining the operating lever 1112 at a desired opening, and a release apparatus 1140 for releasing the one way clutch apparatus 1130 as main constituent parts.

The housing 1110 is formed by a hard synthetic resin material or the like and is provided with a main body portion 1113 integrated with the operating lever 1112 and the operation restricting portion 1120 and the like, a first fixing portion 1114 outwardly fit to a base portion of the handle 1204, and a second fixing portion 1115 fixed to a vertical frame 1205 rising on the back side of the seat.

Describing in details of the respective fixing portions 1114, 1115, the first fixing portion 1114 constitutes a shape of a ring a diameter of which is formed substantially the same as an outer diameter of the handle 1204 and the first fixing portion 1114 is positioned relative the handle 1204 by fitting the handle 1204 to inside thereof. Further, the second fixing portion 1115 is extended along a peripheral direction of the vertical frame 1205 and fixed to the vertical frame 1205 by using a screw or the like.

That is, the housing 1110 is fixed to the handle 1204 by the first fixing portion 1114 and positioned in the peripheral direction of the handle 1204 and in an axial direction of the handle 1204 by the second fixing portion 1115.

The operating lever 1112 is made to be pivotable centering on the supporting shaft 1111 provided at the housing 1110 and can be switched to a total of three modes (operating positions) of “main brake mode”, “auxiliary brake mode”, and “brake release mode”.

First, the main brake mode is a mode capable of operating the brake by a desired brake force in moving forward and moving rearward the wheelchair 1200 and in switching to the main brake mode, the brake force is produced by the above-described main shoe 1004.

Further, the auxiliary brake mode is a mode of automatically operating the brake in moving rearward the wheelchair 1200, that is, in reversely rotating the wheel 1201 and in switching to the auxiliary brake mode, the brake force is produced by the above-described lock shoe 1006.

Further, the brake release mode is a mode in which the brake is not operated in either of forward movement and rearward movement of the wheelchair 1200 and in switching to the brake release mode, both of the main shoe 1004 and the lock shoe 1006 are supported at the positions separated from the inner peripheral face 1003c of the brake drum 1003.

Further, the operating lever 1112 constitutes a neutral position (initial position) by the brake release mode and when the operating lever 1112 is gripped from the neutral position to a side of the handle 1204, the mode is switched to the main brake mode. Further, when the operating lever 1112 is pressed down in a direction of separating from the handle 1204, the mode is switched to the auxiliary brake mode. That is, the mode can be switched to the various modes by operating the operating lever 1112.

Further, with regard to described matters of the scope of claims according to the invention, a position in correspondence with the main brake mode corresponds to a third position. Further, a position in correspondence with the auxiliary brake mode corresponds to a second position. Further, a position in correspondence with the brake release mode corresponds to a first position.

The brake operating apparatus 1100 shown in the embodiment is provided with a pulling amount adjusting apparatus 1150 for changing an amount of pulling the operating lever 1112 in accordance with an operating force other than the one way clutch apparatus 130 and the release apparatus 1140 thereof.

Further, a movable range of the operating lever 1112 is restricted by the operation restricting portion 1120 integrated to the housing 1110 and the operating lever 1112 and the mode can be switched to the respective modes when intentional operation is inputted to the operating lever 1112.

<One Way Clutch Apparatus>

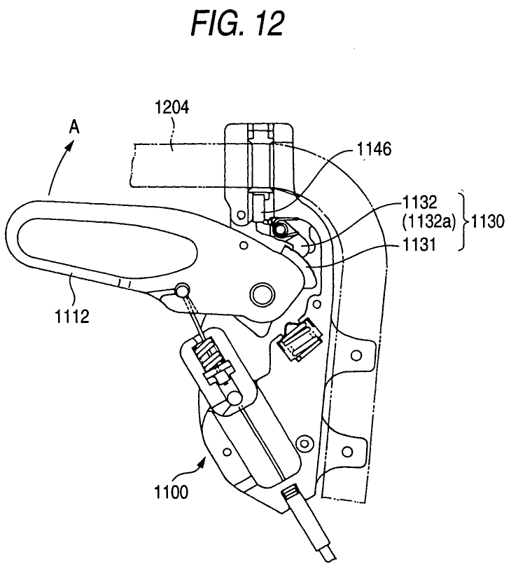

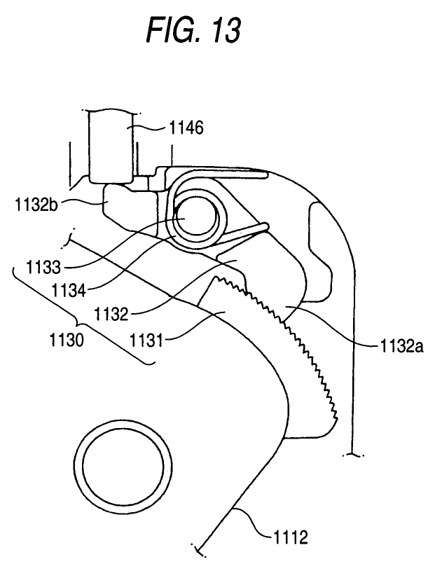

First, an explanation will be given of the one way clutch apparatus 1130 in reference to FIG. 12 and FIG. 13 and the like.

The one way clutch apparatus 1130 is provided with engaging teeth 1131 in a sawtooth shape fixed to a vicinity of a pivoting center of the operating lever 1112 and pivoted along with the operating lever 1112, a claw main body 1132 provided with a claw 1132a brought in mesh with the engaging teeth 1131 in one direction of the engaging teeth 1131 at one end thereof, a supporting shaft 1133 for supporting the claw main body 1132 pivotably relative to the housing 1110, and a spring 1134 for urging the claw 1132a provided at the claw main body 1132 to the engaging teeth 1131.

Further, the engaging teeth 1131 is formed at a position capable of being brought in mesh with the claw main body 1132 (claw 1132a) in switching to the main brake mode and when the engaging teeth 1131 is brought in mesh with the claw main body 1132, the operating lever 1112 is restricted from being pivoted to the side of the brake release mode by the meshing.

That is, in bringing the engaging teeth 1131 in mesh with the claw main body 1132, only operation of the operating lever 1112 to the side of the handle 1104 exerting a brake force, that is, to the side of the main brake mode is permitted, further, the operating lever 1112 is held (constrained) at a position in accordance with an operating amount thereof. Therefore, thereafter, the brake force in accordance with the operating amount is maintained without operating the operating lever 1112.

Further, an operating portion 1145 of the release apparatus 1145 for releasing operation by the one way clutch apparatus 1130 from being restricted is integrated to the first fixing portion 1114 of the housing 1110.

Further, other end of the claw main body 1132 is provided with a rod contact portion 1132b brought into contact with a rod 1146 extended from the operating portion 1145 and the claw main body 1132 is pivoted centering on the supporting shaft 1133 by operation (up and down movement) of the rod 1146 extended from the operating portion 1145.

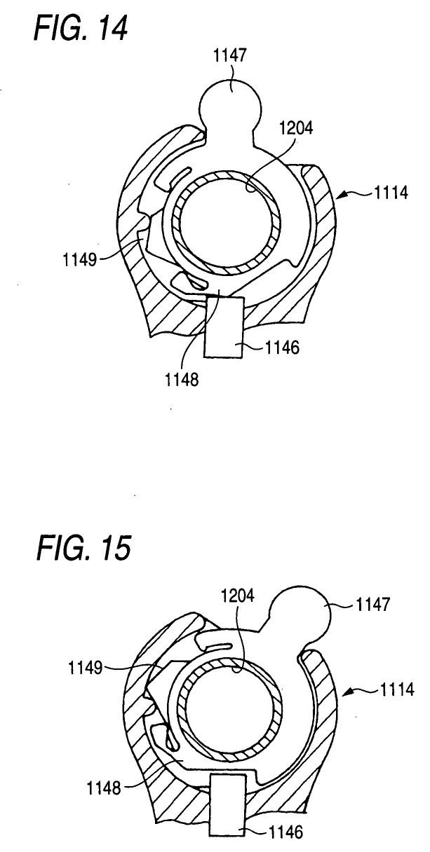

Further, as shown by FIG. 14 and FIG. 15, the operating portion 1145 is provided with the rod 1146 brought into contact with the other end of the claw main body 1132, an operating knob 1147 outwardly fit to the handle 1204 and capable of being operated in a peripheral direction thereof, an operating cam 1148 integrally provided with the operating knob 1147, and an elastic member 1149 in a leaf spring shape deformed by being brought into sliding contact with a projection 1114a formed at an inner face of the first fixing portion 1114 for giving a moderate feeling in operating the operating knob 1147.

Further, explaining an operating state thereof, when the one way clutch apparatus 1130 is not operated, there is brought about a state in which the operating cam 1148 is disposed at an upper end face of the rod 1146 (refer to FIG. 14) and the rod 1146 presses down the other end of the claw main body 1132, that is, the rod contact portion 1132b by the operating cam 1148. Therefore, the claw main body 1132 becomes remote from the engaging teeth 1131 and the claw 1132a provided at the claw main body 1132 is disengaged from the engaging teeth 1132.

That is, when the operating knob 1147 is not operated, there is brought about a state in which the engaging teeth 1131 and the claw 1132a are released from being brought in mesh with each other and the operator (helper) can operate the operating lever 1112 in an arbitrary direction.

Meanwhile, in operating the one way clutch apparatus 1130, as shown by FIG. 15, by operating the operating knob 1146 in the peripheral direction of the handle 1204, the operating cam 1148 is detached from the upper end face of the rod 1146 and the claw 1134a of the claw main body 1132 becomes proximate to the side of the engaging teeth 1131 by tension of the spring 1134 and is brought in mesh with the engaging teeth 1131 again.

Therefore, only operation of the operating lever 1112 to the side of the handle 1204 exerting the brake force is permitted.

In operating the operating knob 1147, the elastic member 1149 is deformed by the projection 1114a, rides over the projection 1114a and thereafter recovered to hold the operating knob 1147 at a pivoted position. Thereby, a position of extracting and retracting the rod 1146 can be prevented from being held at a midway and a concern that the claw 1132a and the engaging teeth 1131 are brought in mesh with each other incompletely to destruct is resolved.

<Pulling Amount Adjusting Apparatus>

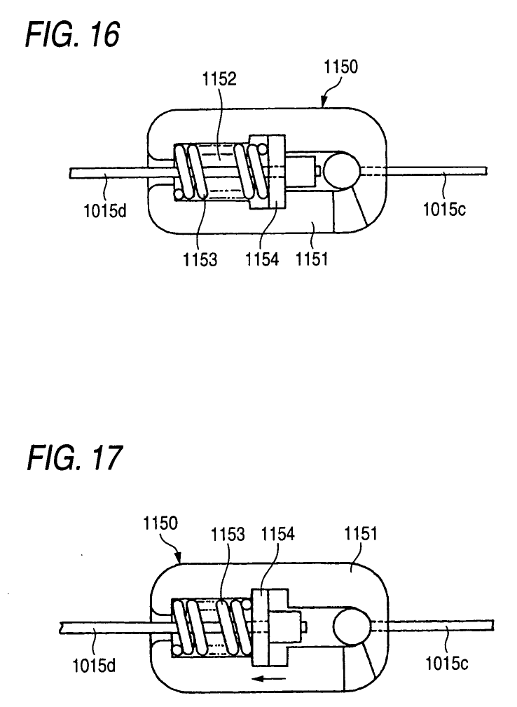

Successively, an explanation will be given of the pulling amount adjusting apparatus 1150 in reference to FIG. 16 and FIG. 17.

The pulling amount adjusting apparatus 1150 is constituted by including a case main body 1151 connected to the operating cable 1015c extended from the operating lever 1015 of the brake apparatus 1001, a coil spring 1153 contained at inside of a containing portion 1152 provided at inside of the case main body 1151 and extended in an axial direction of the case main body 1151, an operating plate 1154 contained in the containing portion 1152 and urged to a side of the operating lever 1015 by the coil spring 1153 at inside of the containing portion 1152, and a connecting cable 1015d one end of which is connected to the operating plate 1154 through inside of the coil spring 1153 and other end of which is connected to the operating lever 1112.

Further, the coil spring 1153 is applied with a pertinent set load and the connecting cable 1015d connected to the operating lever 1112 is always exerted with a pertinent tension force (tension).

Further, when the operating lever 1112 is operated to the side of the main brake mode at and below the set load of the coil spring 1153, the case main body 1151 is moved to the side of the operating lever 1112 in accordance with movement of the connecting cable 1015d. Further, in accordance with movement of the case main body 1151, also the operating lever 1015 is pulled to the side of the operating lever 1112.

Further, when the operating lever 1112 is gripped further from the state, as shown by FIG. 17, the coil spring 1153 at inside of the case main body 1151 is contracted and a stroke is provided to the operating lever 1112 in accordance with an amount of flexing the coil spring 1153.

By the operating force exceeding the set load of the coil spring 1153 in this way, an amount of moving the connecting cable 1015d can be ensured to be larger than an amount of moving the operating cable 1015c connected to the operating lever 1015, as a result, the operating amount of the operating lever 1112 is increased.

Therefore, even at a position at which the engaging teeth 1131 and the claw 1132a are difficult to be brought in mesh with each other, when the operating lever 1112 is gripped by the operating force exceeding the set load of the coil spring 1153, the claw 1132a is brought in mesh with other contiguous tooth of the engaging teeth 1131 and therefore, a state of brining the engaging teeth 1131 and the claw 1130a in mesh with each other is further firmly achieved.

<Operation Restricting Portion>

Successively, the operation restricting portion 1120 will be explained.

As shown by FIG. 11, the operation restricting portion 1120 is provided with a stopper 1122 integrated to inside of a stopper containing portion 1121 formed at the main body portion 1113 of the housing 1110, a spring 1123 (urging member) for urging the stopper 1122 from inside of the stopper containing portion 1121 to the operating lever 1112, and a projected portion 1124 (operation restricting member) brought into contact with the stopper 1122 on the side of the housing 1110.

Further, since the operating lever 1112 is urged in a direction reaching the auxiliary brake mode from the main brake mode by way of the brake release mode by the tension of the above-described operating lever return spring 1015b and therefore, in a normal state (when the operating lever is not operated), the projected portion 1124 of the operating lever 1112 is brought into a state of being brought into contact with the stopper 1122 by an external force in accordance with the urging and the brake release mode constituting a neutral position of the operating lever 1112 is positioned by the state of brining the projected portion 1124 and the stopper 1122 into contact with each other.

In this way, the brake operating apparatus 1100 shown in the embodiment is brought into a state in which the external force in accordance with the urging and a reaction force reacted against the external force are operated to the operating lever 1112 and the operating lever 1112 in the brake release mode is positioned by a balance between the two forces.

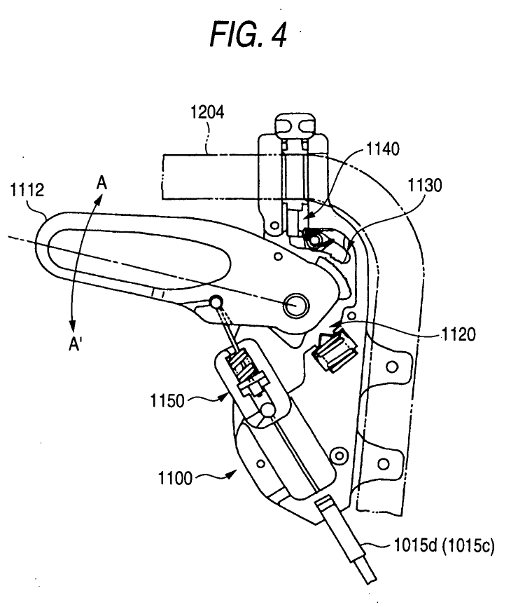

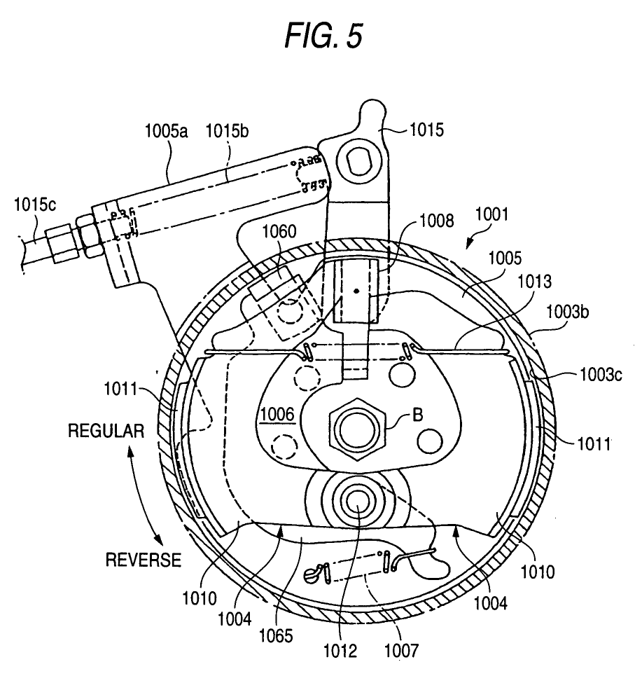

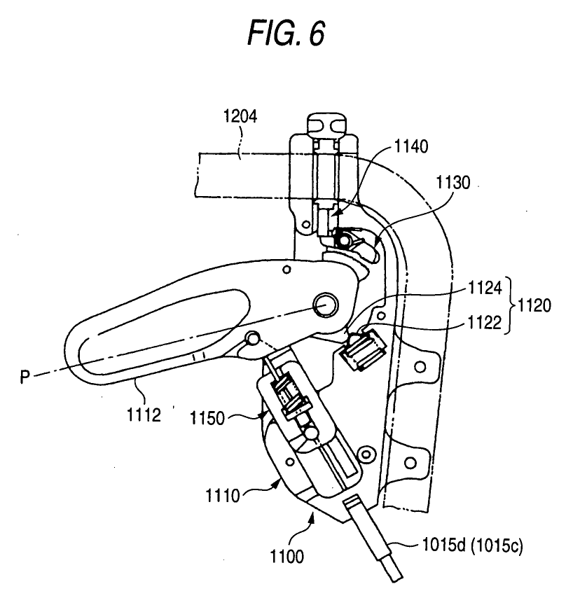

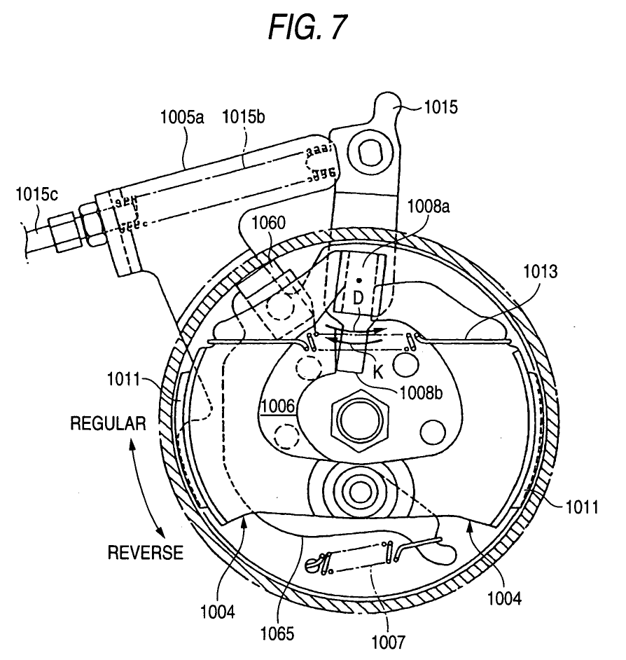

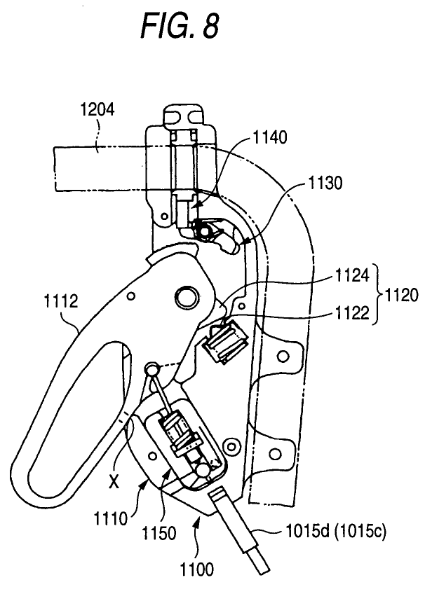

Successively, an explanation will be given of operation of the above-described respective constituent parts in reference to FIG. 3 through FIG. 8. Further, FIG. 3 shows an operating state of the brake apparatus 1001 in correspondence with the main brake mode. Further, FIG. 4 explains an operating state of the operating lever 1112 in correspondence with the main brake mode. Further, FIG. 5 shows an operating state of the brake apparatus 1001 in correspondence with the brake release mode. Further, FIG. 6 explains an operating state of the operating lever 1112 in correspondence with the brake release mode. Further, FIG. 7 shows an operating state of the brake apparatus 1001 in correspondence with the auxiliary brake mode. Further, FIG. 8 explains the operating state of the operating lever 1112 in correspondence with the auxiliary brake mode.

<Main Brake Mode: When the One Way Clutch Apparatus is Not Operated>

First, an explanation will be given of a method of operating the operating lever 1112 when the one way clutch apparatus 1130 is not operated.

When the one way clutch apparatus 1130 is not operated, by gripping the operating lever 1112 by constituting a fulcrum by the handle 1204 (arm), the operating lever 1112 is pivoted in an arrow mark A direction of FIG. 4 (clockwise direction) to provide the brake force in accordance with the operating amount (pivoting amount). Further, when the operation is relaxed, by the tension of the operating lever return spring 1015b, the operating lever 1112 is recovered in an arrow mark A′ direction of FIG. 4 (anticlockwise direction) and the brake force is reduced.

Further, the operation of the respective constituent parts of the brake apparatus 1001 is as follows.

First, when the operating lever 1112 is gripped to operate brake, the operating cam portion 1008a is rotated to a position in accordance with the operating amount (arrow mark N direction in FIG. 3: anticlockwise direction). Further, the respective main shoes 1004, 1004 are pressed to the inner peripheral face 1003c of the brake drum 1003 by a press force in accordance with an operating angle of the operating cam portion 1001a to exert the brake force.

Meanwhile, when the operation is relaxed, by the tensions of the operating lever return spring 1015b and the return spring 1013, the operating cam portion 1008a is recovered in an arrow mark R direction in FIG. 3 (clockwise direction), further, the main shoes 1004, 1004 are separated from the brake drum inner peripheral face 1003c to release brake.

Further, in the main brake mode, the operating cam portion 1008b for the lock shoe 1006 is pivoted in an arrow mark Y direction in FIG. 3 and therefore, by the tension of the lock shoe return spring 1007, the lock shoe 1006 is held at a position further separated from the inner peripheral face 1003c. Therefore, in the main brake mode, the brake force by the lock shoe 1006 is not provided.

<Main Brake Mode: In Operating One Way Clutch Apparatus>

Successively, an explanation will be given of a method of operating the operating lever 1112 in operating the one way clutch apparatus 1130.

In operating the one way clutch apparatus 1130, as shown by FIG. 12, by operation of the one way clutch 1130, only operation of the operating lever 1112 to the side of the handle 1204 exerting the brake force is permitted (arrow mark A direction in FIG. 12). Further, the operating lever 1112 is held at an angle in accordance with the operating amount by being brought in mesh with the claw main body 1132 (claw 1132a).

Therefore, thereafter, until operation by the one way clutch 1130 is released from being restricted, the brake force in accordance with the operating amount is maintained. Therefore, for example, in running at a downhill, the wheelchair 1200 can move down a sloping road while restraining acceleration thereof. Further, at a flat site, the one way clutch apparatus can be utilized also as a parking brake.

Further, operation of the respective constituent parts of the brake apparatus 1001 is as follows.

First, when the operating lever 1012 is gripped, the operating cam portion 1008a is rotated in the arrow mark N direction in FIG. 3 (anticlockwise direction) and the respective main shoes 1004, 1004 are pressed to the inner peripheral face 1003c of the brake drum 1003 to exert brake.

Meanwhile, when operation with respect to the operating lever 1112 is relaxed, by the function of the one way clutch 1130, there is brought about the state in which the angle of the operating lever 1112 is maintained and a state of exerting brake is also maintained thereafter.

<Brake Release Mode>

In the brake release mode, as shown by FIG. 6, there is brought about the state in which the projected portion 1124 of the operating lever 1112 is brought into contact with the stopper 1122 which is a constituent part of the operation restricting portion 1120 and the operating lever 1112 is maintained at the neutral position P by the state of bringing the stopper 1122 and the projected portion 1124 into contact with each other. Further, also the operating cam portion 1008a is similarly maintained at a neutral position and the respective main shoes 1004 are maintained at the positions separated from the brake drum inner peripheral face 1003c by the tension of the return spring 1013.

Further, similar to the main brake mode, also the lock shoe 1006 is brought into a state of being constrained by the lock shoe return spring 1007 and brake is not operated even in moving rearward the wheelchair 1200. In this way, in the brake release mode, both of the respective main shoes 1007 and the lock shoe 1006 are maintained in a state of being separated from the inner peripheral face of the brake drum 1003 and therefore, there is brought about a state in which brake is not operated in either direction of forward movement and rearward movement of the wheelchair 1200.

<Auxiliary Brake Mode>

In switching to the auxiliary brake mode, the operating lever 1112 is pressed down from the brake release mode further to a lower side to switch to the auxiliary brake mode. Further, at this occasion, the projected portion 1124 of the operating lever 1112 brought into contact with the stopper 1122 rides over the stopper 1122 in accordance with forcible pivoting of the operating lever 1112 and positioning of the operating lever 1112 by the operation restricting portion 1120 is released.

Further, simultaneously therewith, the operating lever 1112 is pulled further to the lower side since the operating lever 1112 is operated with the tension of the operating lever return spring 1015b. Further, the operating lever 1112 is brought into contact with the main body portion 1113 of the housing 1110 (refer to point X in FIG. 8) to be positioned thereby.

Further, the operation of the respective constituent parts of the brake apparatus 1001 is as follows.

First, the operating cam portion 1008b is pivoted in an arrow mark K direction in FIG. 7 (clockwise direction) to bring the lock shoe 1006 into contact with the inner peripheral face 1003c of the brake drum 1003.

Further, when the brake drum 1003 is rotated in the reverse rotating direction, the lock shoe 1006 is self-locked to produce the self energizing effect between the lock shoe 1006 and the brake drum 1003 to restrict reverse rotation of the brake drum 1003.

Further, in a situation in which the wheelchair 1200 moves forward and the wheel 1201 is rotated regularly, also the brake drum 1003 is rotated regularly and therefore, the self-lock state of the lock shoe 1006 is released and the wheelchair 1200 can be moved forward.

That is, even when the wheel 1201 is rotated regularly in the auxiliary brake mode, the state of bringing the lock shoe 1006 and the brake drum inner peripheral face 1003c into contact with each other is maintained, however, in regularly rotating the brake drum 1003, the self energizing effect is not achieved and therefore, the brake force by the lock shoe 1006 is not operated to the brake drum 1003.

Further, when the operating lever 1112 is switched to other mode, the operating cam portion 1008b is pivoted in an arrow mark D direction in FIG. 7 and therefore, the lock shoe 1006 returns again to a constant position separated from the brake drum inner peripheral face 1003c by the tension of the lock shoe return spring 1007. Therefore, there is brought about the state in which the brake force by the lock shoe 1006 is not exerted.

In this way, the brake apparatus 1 shown in the embodiment is provided with the operating lever 1112 capable of operating in the movable range including the brake release mode permitting the brake drum 1003 to rotate in both of the regular rotating and reverse rotating directions, the auxiliary brake mode restricting the brake drum 1003 to rotate only in the reverse rotating direction, and the main brake mode restricting the brake drum 1003 to rotate both in the regular rotating and the reverse rotating directions.

Further, the operating lever 1112 is urged in the direction reaching the auxiliary brake mode from the brake release mode in the normal state. Further, the operating lever 1112 is provided with the operation restricting portion 1120 for restricting movement of the operating lever reaching the auxiliary brake mode by being brought into contact with the operating lever 1112 in the brake release mode. That is, the operating lever 1112 is brought into the state of being brought into contact with the operation restricting portion 1120 owing to the external force in accordance with the urging and the brake release mode is positioned by the contact state.

In this way, according to the constitution, there is brought about the state in which the external force in accordance with the urging and the reaction force reacted against the external force are operated to the operation lever 1112 and the operating lever 1112 is positioned by the balance between the two forces. Therefore, since the operating lever 1112 is brought into the state of being always operated with the external force and therefore, in comparison with positioning depending on engagement, the operating lever 1112 can further firmly be positioned. Further, also guide grooves required for the engagement are not needed and various specifications can easily be dealt with by changing the contact portion or the like.

Further, although according to the embodiment, the side of the housing 1110 is provided with the stopper 1122 (contact member) and the spring 1123 (urging member), further, the side of the operating lever 1112 is provided with the projected portion 1124 constituting the operation restricting member, positions of the both can be changed, the stopper 1112 and the spring 1123 may be provided on the side of the operating lever 1112, further, the projected portion 1124 may be provided on the side of the housing 1110.

Further, for example, when the stroke amount or the neutral position of the operating lever 1015 is changed in accordance with a change in the specification of the brake apparatus 1001, the change in the respective specification can easily be dealt with by adjusting a length (adjusting play) of the operating table 1015c or by interchanging the operating lever to an operating lever having a different shape and a position or the like of the projected portion 1124.

Further, also with regard to the position or the like of the engaging teeth 1131 which is the constituent part of the one way clutch apparatus 1130, in accordance with a change or the like in the specification of the brake apparatus 1001, a position, an angle or the like thereof can be changed. Further, when the engaging teeth 1131 are fixed to the operating lever 1112 by a screw or the like, the position of the engaging teeth 1131 can be changed and an angle thereof can be adjusted by relaxing the screw.

Further, although according to the above-described embodiment, an explanation has been given of the operating apparatus 1100 according to the invention by taking an example of the brake apparatus 1 for the wheelchair 1200, the operating apparatus 1100 is applicable not only to the brake of the wheelchair but also to, for example, a brake of a baby buggy, a bicycle, a carriage, an industrial machine, a motor cycle, an automobile or the like.

Further, although according to the embodiment, as the operating apparatus for the helper, the operating apparatus is attached to the handle 1204 for the helper on the back side of the seat, the attaching position can arbitrarily be changed, for example, when the operating apparatus is provided to a rail (arm) extended on the side of the seat, a boarding person of the arm chair 1200 per se can operate the operating lever 1112 to run.

(Second Embodiment)

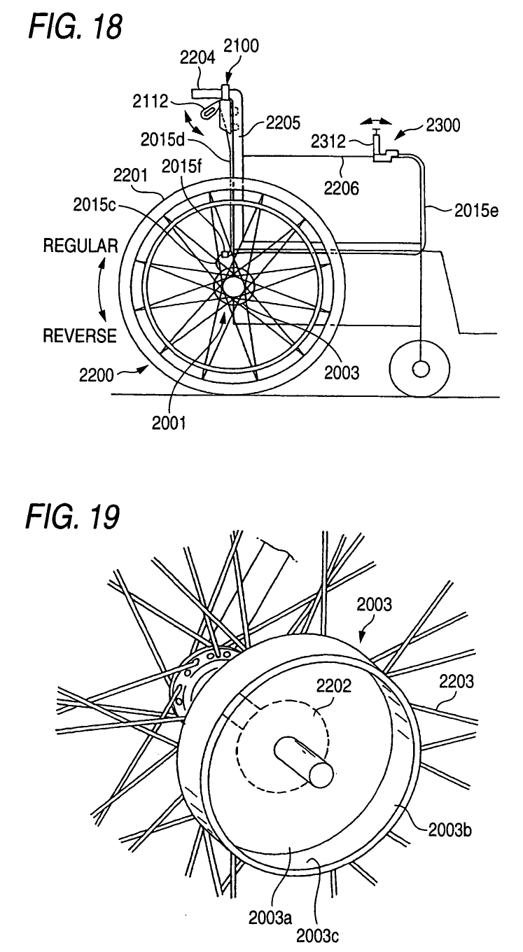

A brake apparatus 2001 shown in a second embodiment is a brake apparatus of a kind generally referred to as “inner expanding type drum brake” and is provided with a brake drum (rotating member) 2003 rotated along with a wheel 2201 as shown by FIG. 18, a main shoe 2004 (main brake member) and a lock shoe 2006 (auxiliary brake member) for producing a brake force by being brought into contact with an inner peripheral face of the brake drum 2003, and a back plate 2005 for supporting the main shoe 2004 and the lock shoe 2006 and the like at inside of the brake drum 2003.

The brake drum 2003 is fixed to a hub 2202 disposed at a rotational center of the wheel 2201 or a spoke 2203 extended radially from the hub 2202 (refer to FIG. 19).

Further in details, the brake drum 2003 is constituted by a circular base portion 2003a fixed to the hub 2202 or the spoke 2203, and a peripheral wall 2003b extended from a peripheral edge of the base portion 2003a toward a side of a frame of a wheelchair 2200 in a state of being mounted to the wheelchair 2200 and an inner peripheral face of the peripheral wall 2003b constitutes a face brought into contact with the main shoe 2004 and the lock shoe 2006.

The back plate 2005 is constituted by a steel plate or the like having a sufficient strength and is attached to between the frame and the wheel 2201 of the wheelchair 2200.

Further in details, an axle is inserted through an axle inserting hole 2005b formed at a center of the back plate 2005 and the back plate 2005 is fastened to fix to the axle by using a bolt 2005c or the like under the state. Further, main constituent parts constituting the brake apparatus 2001 are provided on the back plate 2005 and inside of the brake drum 2003.

As the main constituent parts constituting the brake apparatus 2001, there can be exemplified a pair of the main shoes 2004, 2004 exerting the brake force by being brought into contact with an inner peripheral face 2003c of the brake drum 2003, a return spring 2013 for holding the respective main shoes 2004, 2004 at positions separated from the inner peripheral face 2003c of the brake drum 2003, the lock shoe 2006 for restricting only rotation in a direction of reversely rotating the brake drum by being brought into contact with the inner peripheral face 2003c of the brake drum 2003, a lock shoe return spring 2007 for holding the lock shoe 2006 at a position separated from the inner peripheral face 2003a of the brake drum 2003, and an operating cam 2008 for moving the main shoe 2004 and the lock shoe 2006 individually to positions exerting the brake force against tensions of the respective return springs 2013, 2007.

The pair of main shoes 2004, 2004 each is provided with a main shoe main body 2010 in a bow shape (arch shape) having a contact portion 2004a in contact with the operating cam 2008 at one end thereof and provided with a connecting hole 2004b for receiving an anchor pin 2012 constituting a center of pivoting the main. shoes 2004 at other end thereof, and a lining 2011 constituting contact faces in contact with the main shoe main body 2010 and the brake drum inner peripheral face 2003c and fixed to the side of the main shoe main body 2010. Further, the respective main shoes 2004, 2004 are pivotably attached to the anchor pin 2012 provided on a lower side of the back plate 2005 via the connecting hole 2004b.

That is, the respective main shoes 2004, 2004 are connected to each other via the anchor pin 2012 and in accordance with pivoting the operating cam 2008, the respective main shoes 2004, 2004 are pressed to the brake drum inner peripheral face 2003c to exert the brake force by constituting force operating points by the contact portions 2004a and constituting a fulcrum by the anchor pin 2012.

Further, the respective main shoes 2004, 2004 are connected to each other by the return spring 2013 and are held at the positions separated from the inner peripheral face 2003c of the brake drum 2003 in a normal state. Further, here, the normal state is the state in which an external force in accordance with pivoting the operating cam 2008 is not operated to the main shoe 2004. Further, a detailed description will be given later of operation of the main shoe 2004.

The lock shoe 2006 is provided with a lock lining 2060 for restricting rotation of the brake drum 2003 by being self-locked by being brought into contact with the inner peripheral face 2003c of the brake drum 2003, and a lock shoe main body 2065 fixed with the lock lining 2060.

The lock shoe main body 2065 comprises a flat plate in a bow shape a total length of which is formed to be substantially longer than a shortest distance between the anchor pin 2012 and the brake drum 2003, fixed with the lock lining 2060 at one end thereof and connected with the lock shoe return spring 2007 at other end thereof.

Further, the lock shoe 2006 is provided with a connecting hole 2006a in correspondence with a connecting portion connected with the anchor pin 2012 between the one end provided with the lock lining 2060 and the other end connected with the lock shoe return spring 2007 on other end side thereof connected to the lock shoe return spring 2007. Further, the lock shoe main body 2065 is pivotably attached to the anchor pin 2012 via the connecting hole 2006a.

Further, a contact portion 2006b in contact with the operating cam 2008 is provided at a vicinity of an end portion of the lock shoe main body 2065 fixed with the lock lining 2060 and in correspondence with an angle of the operating cam 2008, the lock shoe main body 2065 is pivoted and at each time thereof, a distance between the brake drum inner peripheral face 2003c and the lock lining 2060 is changed.

Further, the lock shoe 2006 is attached to the anchor pin 2012 in a state of being offset from on a radial line L reaching the anchor pin 2012 from the brake drum 2003 in a regular rotating direction. Therefore, even when the brake drum 2003 is rotated reversely and the lock shoe 2006 and the brake drum 2003 are brought into contact with each other, the lock shoe 2006 is self-locked and a self energizing effect is produced between the lock shoe 2006 and the brake drum 2003. Therefore, reverse rotation of the brake drum 2003 is forcibly restricted by the self energizing effect. The lock shoe 2006 restricts reverse rotation of the brake drum 2003 in this way.

Further, the lock shoe 2006 is held at a position separated from the inner peripheral face 2003c of the brake drum 2003 by the tension of the lock shoe return spring 2007. Therefore, in the normal state (a state in which the brake shoe 2006 is not brought into contact with the inner peripheral face 2003c of the brake drum 2003), the self energizing effect is prevented from being brought about.

The operating cam 2008 is provided with an operating cam portion 2008a for the main shoe 2004 brought into contact with the main shoe main body 2010 at the contact portion 2004a, and an operating cam portion 2008b for the lock shoe 2006 extended further from the operating cam portion 2008a of the main shoe 2004 to an inner side in a diameter direction.

Further, the respective operating cam portions 2008a, 2008b are connected to an operating lever 2015 provided on a back side of the back plate 2005 and the operating cam portion 2008a and the operating cam portion 2008b are integrally pivoted in cooperation with the operating lever 2015.

Further, an end portion of the operating lever 2015 is provided with an operating lever return spring 2015b. The operating lever return spring 2015b is interposed between a return spring support arm 2005a extended from the back plate 2005 and the operating lever 2015 and the operating lever 2015 and is normally urged in a direction of being remote from the return spring support arm 2005a.

Further, an end portion of the operating lever 2015 is connected with an operating cable 2015c as a connecting member according to the invention. Further, the operating cable 2015c is branched to an operating cable 2015d extended to a brake operating apparatus 2100 for a helper fixed to a handle 2204 for a helper on a backside of a seat, and an operating cable 2015e extended to a brake operating apparatus 2300 for a boarding person fixed to an armrest frame 2206 on a side of the seat and connected to operating levers of the brake operating apparatus 2100, 2300 disposed at branch destinations.

Further, the operating cable 2015c is operated by operating a first or a second operating lever 2112, 2312 integrated to the respective brake operating apparatus 2100, 2300 and movement of the operating cable 2015c is transmitted to the operating lever 2015 and the operating cam 2008 is devised to pivot.

Further, a branch point of the operating cable 2015c is provided with a branch apparatus 2015f and operation of the respective brake operating apparatus 2100, 2300 is transmitted to the operating cable 2015c individually and independently from each other via the branch apparatus 2015f.

Successively, a detailed description will be given of structures of the brake operating apparatus 2100 for the helper and the brake operating apparatus 2300 for the boarding person.

<Brake Operating Apparatus for Helper>

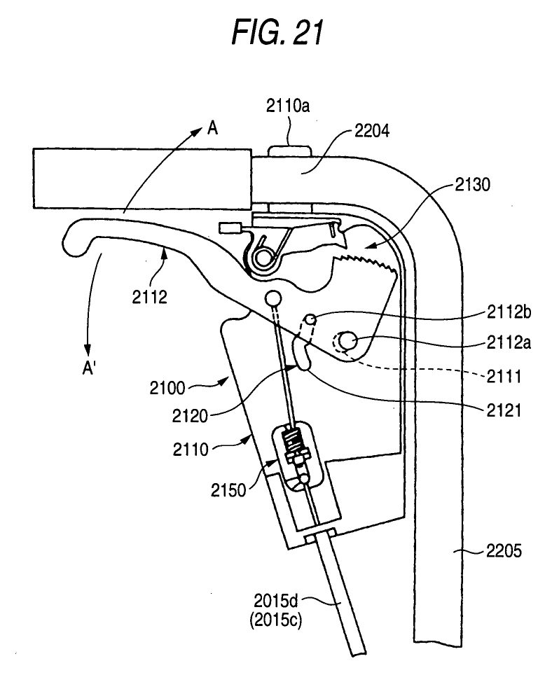

As shown by FIG. 21 and the like, the brake operating apparatus 2100 for the helper is provided with a housing 2110 fixed to the handle 2204 for the helper, the operating lever 2112 (first operating lever) operably (pivotably) supported by the housing 2110, an operation restricting portion 2120 for restricting operation of the operating lever 2112, a one way clutch apparatus 2130 for holding the operating lever 2112 at a desired opening degree, and a release apparatus 2140 for releasing the one way clutch apparatus 2130 as main constituent parts.

The housing 2110 is fixed to a base portion of the handle 2204 via a clamp 2110a. Further, the housing 2110 is formed with a bearing hole 2111 for supporting a supporting shaft 2112a provided integrally with operating lever 2112 at inside thereof.

Further, the operating lever 2112 is supported by the housing 2110 to be able to switch to a total of three modes (operating positions) of a “main brake mode”, an “auxiliary brake mode”, and a “brake release mode” by constituting the supporting shaft 2112a as a center of pivoting.

Further, the main brake mode is a mode capable of operating the brake by a desired brake force in moving forward and moving rearward the wheelchair 2200 and in switching to the main brake mode, the brake force is produced by the above-described main shoe 2004.

Further, the auxiliary brake mode is a mode of automatically operating the brake in moving rearward the wheelchair 2200, that is, in reversely rotating the wheel 2201 and in switching to the auxiliary brake mode, the brake force is produced by the above-described lock shoe 6.

Further, the brake release mode is a mode in which the brake is not operated in either of forward movement and rearward movement of the wheelchair 2200 and in switching to the brake release mode, both of the main shoe 2004 and the lock shoe 2006 are supported at the positions separated from the inner peripheral face 2003c of the brake drum 2003.

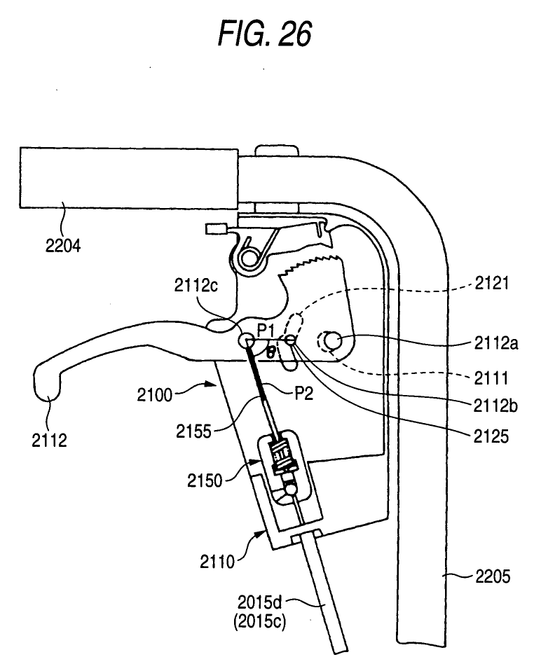

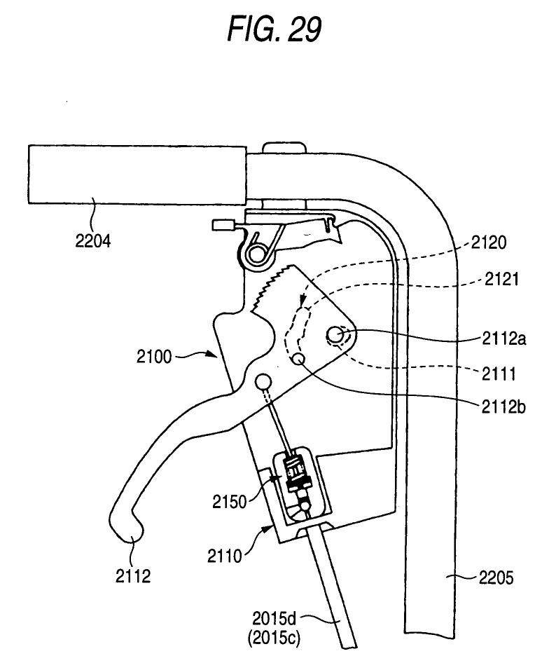

Further, the operating lever 2112 constitutes a neutral position (initial position) (refer to FIG. 26) by the brake release mode and when the operating lever 2112 is gripped from the neutral position to a side of the handle 2204, the mode is switched to the main brake mode (refer to FIG. 21). Further, when the operating lever 2112 is pressed down in a direction of separating from the handle 2204, the mode is switched to the auxiliary brake mode (refer to FIG. 29). That is, the mode can be switched to the various modes by operating the operating lever 2112.

Further, with regard to described matters of the scope of claims according to the invention, a position in correspondence with the main brake mode corresponds to a third position. Further, a position in correspondence with the auxiliary brake mode corresponds to a second position. Further, a position in correspondence with the brake release mode corresponds to a first position.

The brake operating apparatus 2100 shown in the embodiment is provided with a pulling amount adjusting apparatus 2150 for changing an amount of pulling the operating lever 2112 in accordance with an operating force other than the one way clutch apparatus 2130 and the release apparatus 2140 thereof.

Further, a movable range of the operating lever 2112 is restricted by the operation restricting portion 2120 integrated to the housing 2110 and the operating lever 2112 and a moderate feeling to some degree is given by the operation restricting portion 2120 in the operation of switching to the respective modes.

<One Way Clutch Apparatus>

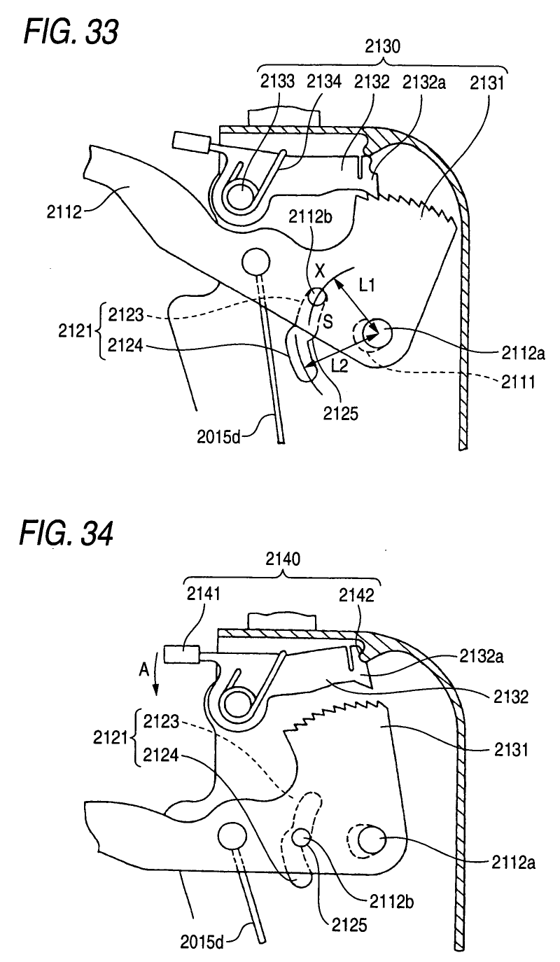

First, an explanation will be given of the one way clutch apparatus 2130 in reference to FIG. 33 and the like.

The one way clutch apparatus 2130 is provided with engaging teeth 2131 in a sawtooth shape formed at a vicinity of a pivoting center of the operating lever 2112 and pivoted along with the operating lever 2112, a claw main body 2132 provided with a claw 2132a brought in mesh with the engaging teeth 2131 in one direction of the engaging teeth 2131 at one end thereof, a supporting shaft 2133 for supporting the claw main body 2132 pivotably relative to the housing 2110, and a spring 2134 for urging the claw 2132a provided at the claw main body 2132 to the engaging teeth 2131.

Further, the engaging teeth 2131 is formed at a position capable of being brought in mesh with the claw main body 2132 (claw 2132a) in switching to the main brake mode and when the engaging teeth 2131 is brought in mesh with the claw main body 2132, the operating lever 2112 is restricted from being pivoted to the side of the brake release mode by the meshing.

That is, in bringing the engaging teeth 2131 in mesh with the claw main body 2132, only operation of the operating lever 2112 to the side of the handle 2104 exerting a brake force, that is, to the side of the main brake mode is permitted, further, the operating lever 2112 is held (constrained) at a position in accordance with an operating amount thereof. Therefore, thereafter, the brake force in accordance with the operating amount is maintained without operating the operating lever 2112.

Further, as shown by FIG. 34, other end of the claw main body 2132 is provided with a release knob 2141 for pivoting the claw main body 2132 in a direction of being remote from the engaging teeth 2131. Further, the claw main body 2132 is provided with an engaging groove 2142 for engaging with the housing 2110 by being pivoted in a direction opposed to the engaging teeth 2131.

Further, when the claw main body 2132 is made to be remote from the engaging teeth 2131 by operating the release knob 2141 (an allow mark A direction in FIG. 34), the claw main body 2132 is engaged with the housing 2110 at the engaging groove 2142 to hamper the claw main body 2132 from returning to a side of the engaging teeth 2131. Therefore, the engaging teeth 2131 and the claw 2132a are released from being brought in mesh with each other to bring about a state in which operation of the operating lever 2112 by the one way clutch apparatus 2130 is released from being restricted.

<Pulling Amount Adjusting Apparatus>

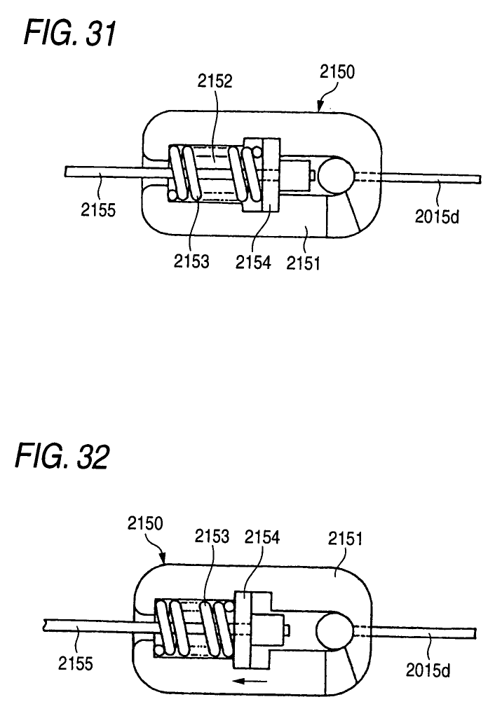

Successively, an explanation will be given of the pulling amount adjusting apparatus 2150 in reference to FIG. 31 and FIG. 32 and the like.

The pulling amount adjusting apparatus 2150 is provided with a case main body 2151 connected to the operating cable 2015d (first connecting member) extended from the operating lever 2015 via the operating cable 2015c, a coil spring 2153 contained at inside of a containing portion 2152 extended in an axial direction of the case main body 2151, a movable plate 2154 contained in the containing portion and urged to a side of the operating lever 2015 by the coil spring 2153 at inside of the containing portion 2152, and a connecting cable 2155 (second connecting member) one end of which is connected to the movable plate 2154 through inside of the coil spring 2153 and other end of which is connected to the operating lever 2112 of the brake operating apparatus 2100.

Further, the coil spring 2153 is applied with a pertinent set load and the connecting cable 2015d connected to the operating lever 2112 is always exerted with a pertinent tension force (tension).

Further, when the operating 2112 is operated to a side of the main brake mode by the set load or smaller of the coil spring 2153, the case main body 2151 is moved to the side of the operating lever 2152 in accordance with movement of the connecting cable 2155. Further, in accordance with movement of the case main body 2151, the operating cable 2015d (operating cable 2015c) is exerted with tension to pivot the operating lever 2015 to the side of the operating lever 2112.

Further, when the operating lever 2112 is gripped further from the state, as shown by FIG. 32, the coil spring 2153 at inside of the case main body 2151 is contracted and a stroke is provided to the operating lever 2112 in accordance with an amount of flexing the coil spring 2153.

By the operating force exceeding the set load of the coil spring 2153 in this way, an amount of moving the connecting cable 2015d can be ensured to be larger than an amount of moving the operating cable 2015c connected to the operating lever 2015, as a result, the operating amount of the operating lever 2112 is increased.

Therefore, even at a position at which the engaging teeth 2131 and the claw 2132a are difficult to be brought in mesh with each other, when the operating lever 2112 is gripped by the operating force exceeding the set load of the coil spring 2153, the claw 2132a is brought in mesh with other contiguous tooth of the engaging teeth 2131 and therefore, a state of brining the engaging teeth 2131 and the claw 2130a in mesh with each other is further firmly achieved.

<Operation Restricting Portion>

Successively, an explanation will be given of the operation restricting portion 2120.

As shown by FIG. 33 through FIG. 35, the operation restricting portion 2120 is constituted by including a guide groove 2121 formed at the housing 2110, and a guide pin 2112b formed on a side of the operating lever 2112.

The guide groove 2121 is provided with a path 2123 for the main brake mode drawing an arc centering on the supporting shaft 2112a disposed at the pivoting center of the operating lever 2112, and a path 2124 for the auxiliary brake mode drawing an arc centering on the supporting shaft 2112a. The respective paths 2123, 2124 are connected at respective end portions thereof.

Further, as shown by FIG. 33, a distance L1 reaching the path 2123 for the main brake mode from the supporting shaft 2112a and a distance L2 reaching the path 2124 for the auxiliary brake mode from the supporting shaft 2112a differ from each other and the side of the path 2123 of the main brake mode is formed by drawing the arc of a smaller diameter (L2>L1).

Further, since radii of curvature of the respective paths 2123, 2124 differ from each other, the connecting portion of the path 2123 for the main brake mode and the path 2124 for the auxiliary brake mode is formed with a bent portion 2125 bent in a direction of being remote from the supporting shaft 2112a in a procedure of reaching the path 2124 for the auxiliary brake mode from the path 2123 for the main brake mode.

Further, in operating the operating lever 2112, the guide pin 2112b provided at the operating lever 2112 is guided along the guide groove 2121.

Successively, an explanation will be given of relative positions of the guide groove 2121 and the guide pin 2112b in view of switching to the respective modes.

First, as shown by FIG. 33, in switching to the main brake mode, in accordance with pivoting the operating lever 2112 toward the handle 2204, the guide pin 2112b is guided along the path 2123 of the main brake mode.

Further in details, when the operating lever 2112 is gripped to the side of the handle 2204, the guide pin 2112b is slid along the bent portion 2125 formed at inside of the guide groove 2121 as a start point to a final end X of the path 2123 for the main brake mode.

When the operating lever 2112 is set free under the state, the operating lever 2112 returns to the side of the auxiliary brake mode by tension of the operating lever return spring 2015b and in accordance with the returning, the guide pin 2112b is slid to a start end S of the path 2123 for the main brake mode.

Further, since the bent portion 2125 is formed at the start end S of the path 2123 for the main brake mode as described above, the guide pin 2112b is brought into contact with the bent portion 2125 from the side of the path 2123 for the main brake mode in accordance with urging the operating lever 2112 to the side of the auxiliary brake mode (refer to FIG. 34).

Therefore, the operating lever 2112 is restricted in operation thereof reaching the auxiliary brake mode by forming a contact state between the bent portion 2125 and the guide pin 2112b. Further, positioning in the brake release mode in correspondence with the neutral position is carried out by the contact state between the bent portion 2125 and the guide pin 2112b.

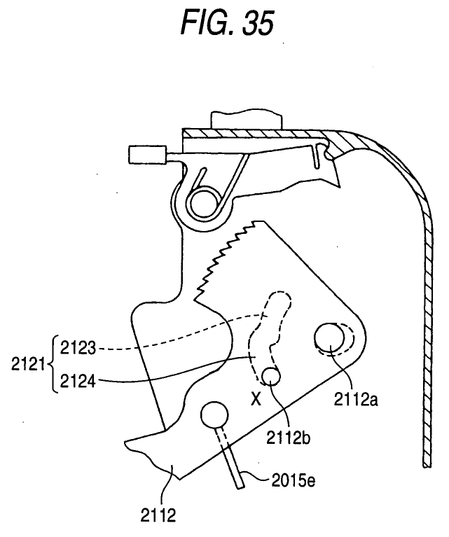

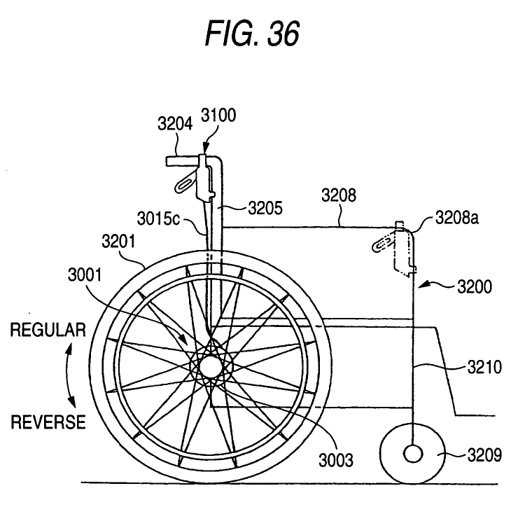

Successively, an explanation will be given of switching to the auxiliary brake mode in reference to FIG. 35.

In switching to the auxiliary brake mode, while pulling the operating lever 2112 in a direction opposed to the supporting shaft 2112a, the operating lever 2112 is further operated to a lower side of the housing 2110.

Further, in accordance with the operation, the contact is state between the bent portion 2125 and the guide pin 2112b is released and the guide pin 2112b is moved to the path 2124 of the auxiliary brake mode.

Further, since the operating lever 2112 is operated with the tension of the operating lever return spring 2015b, the operating lever 2112 is slid to a final end X of the path 2124 for the auxiliary brake mode in accordance with release of the contact state at the bent portion 2125. Further, the guide pin 2112b is butted to the final end X of the path 2124 for the auxiliary brake mode (refer to FIG. 35) to thereby position the operating lever 2112 in the auxiliary brake mode.

Further, the radius of curvature of the path 2124 for the auxiliary brake mode is made to be larger than the radius of curvature of the path 2123 of the main brake mode as described above.

Therefore, in order to deal with the difference between the radii of curvature, the supporting shaft receiving hole 2111 formed at the housing 2110 is formed by a slightly long hole prolonged to the guide groove 2121.

Therefore, by moving the supporting shaft 2112a to the side of the guide groove 2121 of the bearing hole 2111 formed in the long hole, the guide pin 2112b can be moved from the path 2123 for the main brake mode to the path 2124 for the auxiliary brake mode.

Further, according to the embodiment, in order to ensure the contact state between the bent portion 2125 and the guide pin 2112b, an angle of attaching the connecting cable 2115 (operating cable 2015d) is determined such that a force in a direction directed to the supporting shaft receiving hole 2111 is operated to the guide pin 2112b.

Further, explaining in reference to FIG. 26, in a state of bringing the guide ping 2112b into contact with the bent portion 2125, by constituting a base point by a connecting portion 2112c for connecting the operating lever 2112 and the connecting cable 2115, the angle of attaching the connecting cable 2115 is determined such that an angle E made by an imaginary line P1 reaching the guide pin 2112b from the base point and an imaginary line P2 extended from the base point along a direction of extending the connecting cable 2155 becomes an acute angle.

Therefore, in switching to the brake release mode, the contact state between the guide pin 2112b and the bent portion 2125 is ensured.

<Brake Operating Apparatus for Boarding Person>

Successively, an explanation will be given of the brake operating apparatus 2300 for the boarding person.

Further, although the brake operating apparatus 2300 for the boarding person differs from the above-described brake operating apparatus 2100 for the helper in a shape thereof, constituent parts thereof and operation of the respective constituent parts are much in correspondence with those of the brake operating apparatus 2100 for the helper and in the following, in view of the above-described explanation of the brake operating apparatus of the helper, an explanation will be given of the brake operating apparatus 2300 for the boarding person by partially simplifying the explanation.

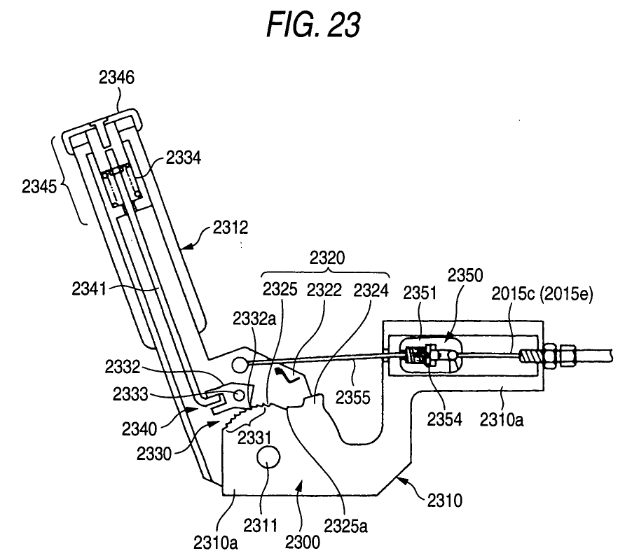

As shown by FIG. 23 and the like, the brake operating apparatus 2300 for the boarding person is provided with a housing 2310, the operating lever 2312 (second operating lever) pivotably connected to the housing 2310 via a supporting shaft 2311, an operation restricting portion 2320 for restricting operation of the operating lever 2312, a one way clutch apparatus 2330 for constraining the operating lever 2312 by a desired opening degree, a release apparatus 2340 for releasing the one way clutch apparatus 2330, and a spring amount adjusting apparatus 2350 connected to the operating cable 2015c (operating cable 2015e).

The housing 2310 is provided with a main body portion 2310a for supporting a base portion of the operating lever 2312 and an operating cable supporting portion 2310b integrated with the pulling amount adjusting apparatus 2350 and is fixed to the armrest frame 2206 on the side of the seat (refer to FIG. 18).

Further, the operating cable 2015e extended from the operating lever 2015 is drawn to inside of the operating cable supporting portion 2310b and a front end thereof is connected to a case main body 2351 of the pulling amount adjusting apparatus 2350. Further, a connecting cable 2355 is extended from the pulling amount adjusting apparatus 2350 to an operating lever 2312 and the operating lever 2312 is connected to an operating plate 2354 of the pulling amount adjusting apparatus 2350 via the connecting cable 2355.

The operating lever 2310 is pivotable in a forward and rearward direction of the wheelchair 2200 centering on the supporting shaft 2311 provided at the housing 2310 and can be switched to a total of three modes (operating positions) of a “main brake mode”, an “auxiliary brake mode”, and a “brake release mode” similar to the brake operating apparatus 2100 for the helper.

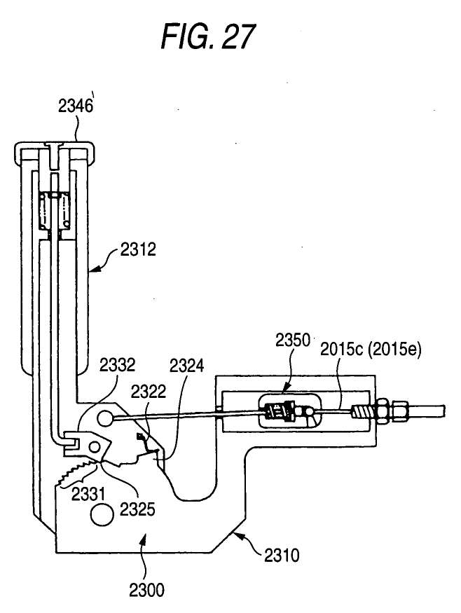

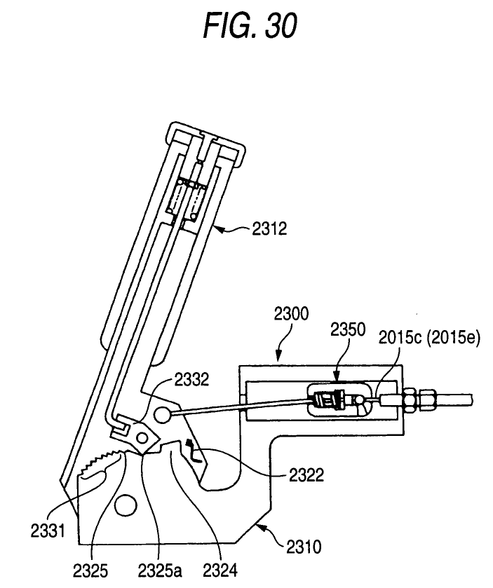

Further, a neutral position of the operating lever 2312 is constituted by the brake release mode (refer to FIG. 27) and when the operating lever 2312 is pulled from the neutral position to a rear side of the wheelchair 2200, the brake release mode is switched to the main brake mode (refer to FIG. 23). Further, when the operating lever 2312 is brought down to a front side of the wheelchair 2200, the brake release mode is switched to the auxiliary brake mode (refer to FIG. 30). That is, similar to the brake operating apparatus 2100 for the helper, the mode can be switched to the various modes by pivoting operation of the operating lever 2112

Further, with regard to described matters of the scope of claims according to the invention, a position in correspondence with the main brake mode corresponds to a third position. Further, a position in correspondence with the auxiliary brake mode corresponds to a second position. Further, a position in correspondence with the brake release mode corresponds to a first position.

Further, a movable range of the operating lever 2312 is restricted by the operating restricting portion 2320 integrated to the housing 2310 and the mode can be switched to the respective modes in inputting intentional operation to the operating lever 2312.

Further, according to the brake operating apparatus 2300 for the boarding person, portions of constituent parts of the one way clutch apparatus 2330 are commonly used for parts constituting the operation restricting portion 2320.

A detailed description will be given of the one way clutch apparatus 2330 in view of the explanation of the operation restricting portion 2320 as follows.

<One Way Clutch Apparatus>

Similar to the brake operating apparatus 2100 for the helper, the one clutch apparatus 2330 is provided with engaging teeth 2331 in a sawtooth shape and a claw main body 2332 having a claw 2332a brought in mesh with the engaging teeth 2331 in one direction thereof.

Further, as a point of difference from the brake operating apparatus 2100 for the helper, the housing 2310 is formed with the engaging teeth 2331 and the claw main body 2332 and the release apparatus 2340 are integrated to the operating lever 2312. Further, an operating portion 2345 for operating the release apparatus 2340 is provided at the operating lever 2312.

As shown by FIG. 23, the engaging teeth 2331 are constituted by providing a plurality of streaks of teeth cut to a front side of the housing 2310. Further, the position of the engaging teeth 2331 is formed at a position of being brought in mesh with the claw main body 2332 (claw 2332a) of the operating lever 2312 when the operating lever 2312 is operated to the side of the main brake mode.

Further, the claw main body 2332 is provided pivotably in a total of two directions of a direction of being proximate to the engaging teeth 2331 and a direction of being remote from the engaging teeth 2331 centering on a supporting shaft 2333 fixed to the operating lever 2312.

Further, other end of the claw 2332a is connected with a release rod 2341 extended in an axial direction of the operating lever 2312 through inside of the operating lever 2312 as a constituent part of the release apparatus 2340.

Further, a front end of the release rod 2341 is provided with an operation button 2346 for operating the release rod 2341 in the axial direction of the operating lever 2312. Further, inside of the operating lever 2312 is provided with a spring 2334 for urging the release rod 2341 to a side of the front end of the operating lever 2312 by way of the operation button 2346.

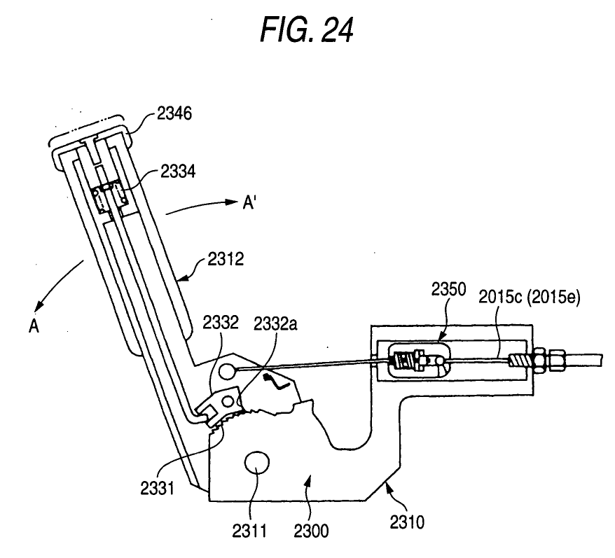

Therefore, by tension of the spring 2334, the claw main body 2332 is brought into a state of being urged to the side of the engaging teeth 2331 in a normal state, further, when the operation button 2346 is pressed against the tension of the spring 2334, in accordance with operation of the release rod 2341, the claw main body 2332 is pivoted in a direction of separating from the engaging teeth 2331 (refer to FIG. 24).

<Operation Restricting Portion>

Successively, an explanation will be given of the operation restricting portion 2320.

As shown by FIG. 27, the operation restricting portion 2320 is provided with a stopper 2322 fixed to the operating lever 2312, a projected portion 2324 provided at the housing 2310 and brought into contact with the stopper 2322 in operating to the brake release mode, an operation restricting claw 2325 provided continuously to the engaging teeth 2331, and the claw main body 2332 which is the constituent part of the one way clutch apparatus 2340.

The stopper 2322 is constituted by a bent leaf spring to be brought into face contact with the projected portion 2324 provided at the housing 2310 and as shown by FIG. 27, when the operation lever 2312 is switched to the brake release mode, the stopper 2322 is brought into contact with the projected portion 2324 of the housing 2310 to position the operating lever 2312.

Further, the operation restricting claw 2325 provided continuously to the engaging teeth 2331 is cut to the front direction of the housing 2310 similar to the plurality of streaks of teeth formed at the engaging teeth 2331, further, a position thereof is provided at a position of capable of being brought in mesh with the claw main body 2332 (claw 2332a) when the operating lever 2312 is switched to the brake release mode.

Therefore, when the operation restricting claw 2325 and the claw main body 2332 are brought in mesh with each other (brought into contact with each other), by forming the meshed state, operation of the operating lever 2312 from the side of the brake release mode to the auxiliary brake mode is restricted. Further, the operating lever 2312 is positioned.

Further, the operating lever 2312 is operated with the tension of the operating lever return spring 2015b and urged to a direction reaching the auxiliary brake mode in the normal state and therefore, there is brought about a state in which an external force in accordance with the urging and a reaction force caused by the contact at the respective portions are operated to the operating lever 2312 and the operating lever 2312 is positioned in the brake release mode by a balance of the two forces.

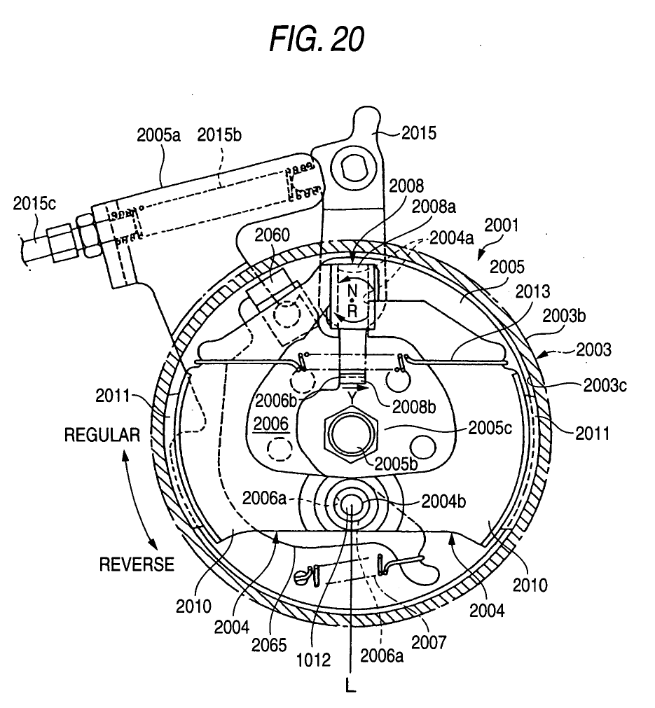

Successively, an explanation will be given of the brake apparatus 2001 and the brake operating apparatus 2100, 2300 with regard to a state of operating respective constituent parts thereof in reference to FIG. 20 through FIG. 30.

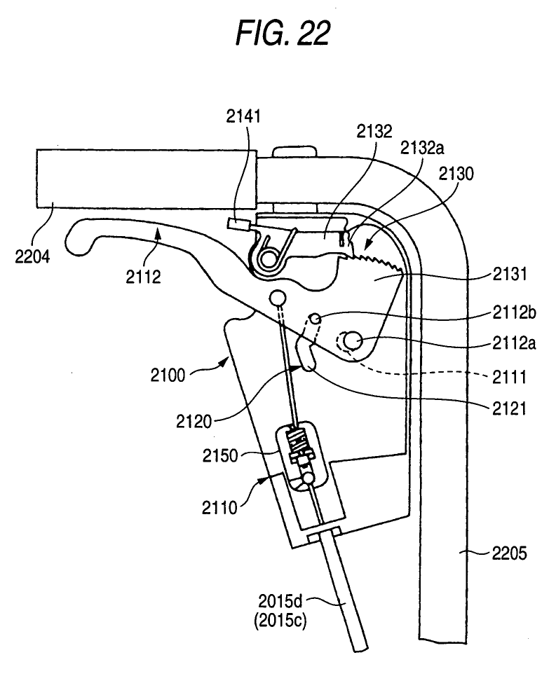

FIG. 20 shows an operating state of the brake apparatus 2001 in correspondence with the main brake mode. Further, FIG. 21 and FIG. 22 explain the operating state of the brake operating apparatus 2100 in the main brake mode. Further, FIG. 23 and FIG. 24 explain the operating state of the brake operating apparatus 2300 for the boarding person in the main brake mode.

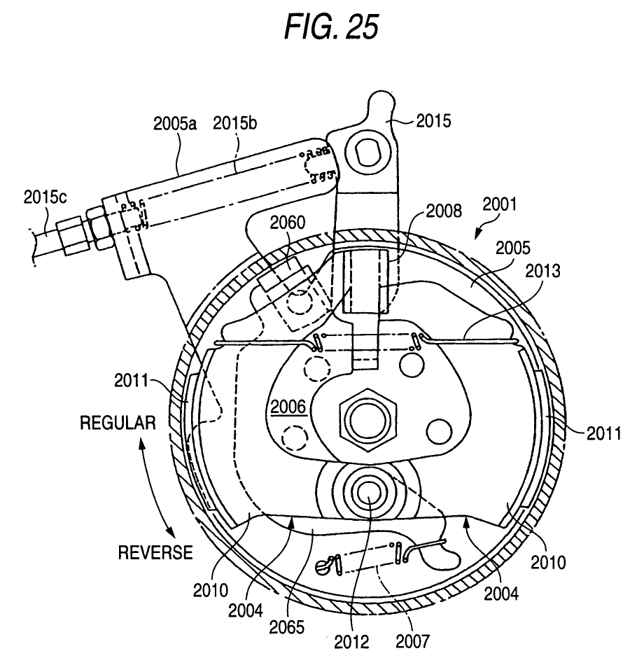

Further, FIG. 25 shows the operating state of the brake apparatus 2001 in correspondence with the brake release mode. Further, FIG. 26 explains the operating state of the brake operating apparatus 2100 for the helper in correspondence with the brake release mode. Further, FIG. 27 explains the operating state of the brake operating apparatus 2300 for the boarding person in correspondence with the brake release mode.

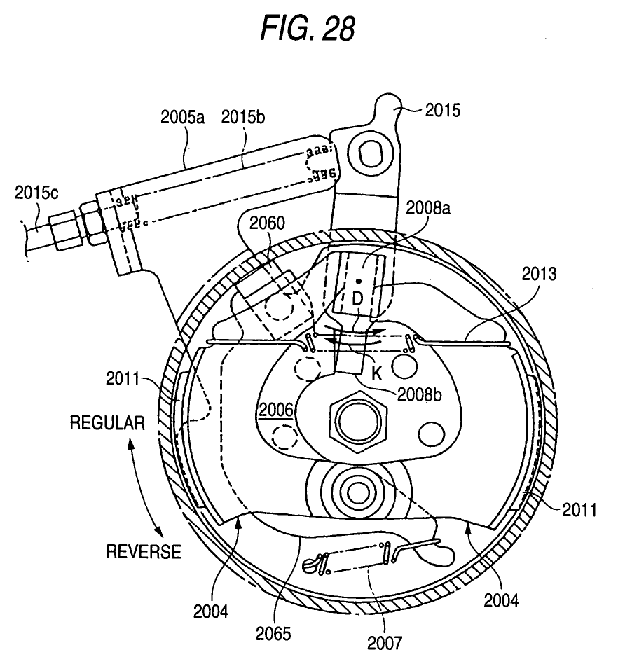

Further, FIG. 28 shows the operating state of the brake apparatus 2001 in correspondence with the auxiliary brake mode. Further, FIG. 29 explains the operating state of the brake operating apparatus 2100 for the helper in correspondence with the auxiliary brake mode. Further, FIG. 30 explains the operating state of the brake operating apparatus 2300 for the boarding person in correspondence with the auxiliary brake mode.

<Main Brake Mode: When the One Way Clutch Apparatus is Not Operated>

First, an explanation will be given of a method of operating the respective brake operating apparatus 2100, 2300 when the respective one way clutch apparatus 2130, 2330 are not operated.

In order to bring about a state in which the one way clutch apparatus 2130 is not operated in the brake operating apparatus 2100 for the helper, the release knob 2141 provided at the other end of the claw main body 2132 is pressed down to bring about the state in which the one way clutch apparatus 2130 is not operated.

Further, by gripping the operating lever 2112 to the side of the handle 2204 by constituting the fulcrum by the handle 2204, the first operating lever 2112 is pivoted in an arrow mark A direction in FIG. 21 (clockwise direction) to provide the brake force in accordance with the operating amount (opening degree). Further, when the operation is relaxed, the operating lever 2112 returns in an arrow mark A′ direction in FIG. 21 (anticlockwise direction) by the tension of the operating lever return spring 2015b to reduce the brake force.

Meanwhile, in the brake operating apparatus 2300 for the boarding person, first, the operating button 2346 is pressed to the side of the second operating lever 2312 to bring about the state in which the one way clutch apparatus 2340 is not operated. Further, by pulling the operating lever 2312 to the rear side of the wheelchair 2200 while pressing the operating button 2346, the operating lever 2312 is pivoted in an arrow mark A direction in FIG. 24 (clockwise direction) to provide the brake force in accordance with the operating amount. Further, when the operation is relaxed, the operating lever 2312 returns in a narrow mark A′ direction in FIG. 24 (anticlockwise direction) by the tension of the operating lever return spring 2015b to reduce the brake force.

Further, the respective constituent parts of the brake apparatus 2001 are operated as follows.

First, when the operating lever 2112 (2312) of the brake operating apparatus 2100 for the helper or the brake operating apparatus 2300 for the boarding person is operated, the operating cam portion 2008a is rotated by an operating angle in accordance with the operating amount (an arrow mark N direction in FIG. 20: anticlockwise direction). Further, the respective main shoes 2004, 2004 are pressed to the inner peripheral face 2003c of the brake drum 2003 by the press force in accordance with the operating angle of the operating cam portion 2008a to exert the brake force.

Meanwhile, when the operation is relaxed, the operating cam portion 2008a returns in an arrow mark R direction in FIG. 20 (clockwise direction) by the tension of the operating lever return spring 2015b and the return spring 2013, further, the respective main shoes 2004, 2004 are separated from the brake drum inner peripheral face 2003c to release the brake.

Further, in the main brake mode, the operating cam portion 2008b of the lock shoe 2006 is pivoted in an arrow mark Y direction in FIG. 20, the lock shoe 2006 is maintained at the position of being further remote from the inner peripheral face 2003c of the brake drum 2003 by the tension of the lock shoe return spring 2007. Therefore, in the main brake mode, the brake force by the lock shoe 2006 is not exerted.

<Main Brake Mode: In Operating the One Way Clutch Apparatus>

Successively, an explanation will be given of a method of operating the respective brake operating apparatus 2100, 2300 in operating the one way clutch apparatus 2130, 2330.

In operating the one way clutch apparatus 2130 of the brake operating apparatus 2100 for the helper, as shown by FIG. 22, by operation of the one way clutch apparatus 2130, only operation of the operating lever 2112 to the side of the handle 2204 exerting the brake force is permitted. Further, the operating lever 2112 is held at an angle in accordance with the operating amount at each time by being brought in mesh with the claw main body (claw 2132a).

Further, in operating the one way clutch apparatus 2330 of the brake operating apparatus 2300 for the boarding person, as shown by FIG. 23, by operating the one way clutch apparatus 2330, only operation of the operating lever 2312 to the rear side of the wheelchair exerting the brake force is permitted. Further, the operating lever 2312 is maintained at an angle in accordance with the operating amount at each time by being brought in mesh with the claw main body 2332 (claw 2332a).

Therefore, thereafter, in both of the brake operating apparatus 2100 for the helper and the brake operating apparatus for the boarding person, the brake force in accordance with the operating amount (opening degree) is maintained until the state in which the one way clutch apparatus is not operated. Therefore, at a downhill or the like, a sloping path can be moved down while restraining acceleration of the wheelchair 2200. Further, at a flat side, the brake can also be utilized as a parking brake.

Further, the respective constituent parts of the brake apparatus 2001 are operated as follows.

First, when the operating lever 2112 or the operating lever 2312 is operated to operate the brake, the operating cam portion 2008a is rotated in the arrow mark N direction in FIG. 21 (anticlockwise direction) and the main shoes 2004, 2004 are pressed to the inner peripheral face 2003c of the brake drum 2003 to exert brake.

Meanwhile, when the operation of the operating lever 2112, 2312 is relaxed, by the function of the one way clutch apparatus 2130, there is brought about a state in which the angles of the operating lever 2112, 2312 are maintained and the braked state continues thereafter.

<Brake Release Mode>

When the mode is switched to the brake release mode on the side of the brake operating apparatus 2100 for the helper, as described above, there is brought about a state in which the bent portion 2125 of the guide groove 2121 and the guide pin 2112b are brought into contact with each other and the operating lever 2112 is maintained at the neutral position by forming the contact state.

Further, when the mode is switched to the brake release mode on the side of the brake operating apparatus 2300 for the boarding person, as described above, there is brought about the state in which the stopper 2322 and the projected portion 2324 are brought into contact with each other, further, there is brought about the state in which the operation restricting claw 2325 and the claw main body 2332 are brought in mesh with each other, and by forming the contact states (meshed state) at the respective portions, the operating lever 2312 is maintained in the brake release mode (neutral position).

Therefore, also the operating cam portion 2008a is maintained in the neutral state and the respective shoes 2004 are maintained at positions separated from the brake drum inner peripheral face 2003c by the tension of the return spring 2013.

Further, also the lock shoe 2006 is brought into a state of being constrained by the lock shoe return spring 2007 similar to the main brake mode and even in rearward movement of the wheelchair 2200, the brake is not operated.

In this way, in the brake release mode, there is maintained the state in which both of the respective main shoe 2004 and the lock shoe 2006 are separated from the inner peripheral brake drum 2003 and therefore, there is brought about a state in which the brake is not operated in either of directions of forward movement and the rearward movement of the wheelchair 2200.

<Auxiliary Brake Mode>

In switching to the auxiliary brake mode in the brake operating apparatus 2100 for the helper, the operating lever 2112 is pressed down to the lower side further from the brake release mode to switch to the auxiliary brake mode. Further, at this occasion, the guide pin 2112b of the operating lever 2112 which has been in the state of being brought into contact with the bent portion 2125 is released from the contact state at the bent portion 2125 by forcibly pivoting the operating lever 2112 and operation of the operation restricting portion 2120 having the bent portion 2125 and the guide pin 2112b is released from restricting.

Further, simultaneously therewith, since the operating lever 2112 is operated with the tension of the operating lever return spring 2015b, the operating lever 2112 is moved further to the lower side along the path 2124 for the auxiliary brake mode. Further, the guide pin 2112b is butted to the final end X of the path 2124 of the auxiliary brake mode (refer to FIG. 33) to be positioned thereby.

Further, in switching to the auxiliary brake mode in the brake operating apparatus 2300 for the boarding person, the operating button 2346 is pressed to the side of the operating lever 2312 to release the operation restricting claw 2325 and the claw main body 2332 from being brought in mesh with each other. Further, when the operating lever 2312 is operated in a direction reaching the auxiliary brake mode, the stopper 2322 (leaf spring) is bent to ride over the projected portion 2324 of the housing 2310 to thereby release the contact state between the stopper 2322 and the projected portion 2324.

Further, since the operating lever 2312 is operated with the tension of the operating lever return spring 2015b, the operating lever 2312 is pulled to the cable connecting portion 2310a. Further, according to the embodiment, the operation restricting claw 2325a is provided on further front side of the operation restricting claw 2325 and the claw 2332a of the claw main body 2332 and the operation restricting claw 2325a are brought in mesh with each other to thereby position the operating lever 2312 in the auxiliary brake mode.

Further, operation of the respective constituent parts of the brake apparatus 2001 is as follows.

First, the operating cam portion 2008b is pivoted in the arrow mark K direction in FIG. 28 (clockwise direction) to bring the lock shoe 2065 into contact with the inner peripheral face 2003c of the brake drum 3.

Further, when the brake drum 2003 is rotated in the reverse rotating direction, the lock shoe 6 is self-locked, the self energizing effect is produced between the lock shoe 6 and the brake drum 2003 and rotation thereof in the direction of reversely rotating the brake drum is restricted.

Further, in a situation in which the wheelchair 2200 is moved forward and the wheel 2201 is rotated regularly, also the brake drum 2003 is rotated regularly and therefore, the lock shoe 2006 is released from the self-lock state to thereby enable to move the wheel 2201 forward.

That is, even when the wheel 2201 is rotated regularly in the auxiliary brake mode, the contact state of the lock shoe 2006 and the brake drum inner peripheral face 2003c is maintained, however, in regularly rotating the brake drum, the self energizing effect is not achieved and therefore, brake is not operated to the brake drum 2003.

Further, when the operating lever 2312 is switched to other mode, the operating cam portion 2008b is pivoted in an arrow mark D direction in FIG. 28 and therefore, the lock shoe 2006 returns again to a constant position separated from the brake drum inner peripheral face 2003c by the tension of the lock shoe return spring 2007. Therefore, there is brought about a state in which the brake force by the lock shoe 2006 is not exerted.

In this way, according to the embodiment, there are provided the first and the second operating levers 2112, 2312 capable of operating in the movable range including the brake release mode permitting both of regular rotation and reverse rotation of the brake drum 2003, the auxiliary brake mode for restricting only reverse rotation of the brake drum 2003, and the main brake mode for restricting both of regular rotation and reverse rotation of the brake drum 2003.

Further, the respective operating levers 2112, 2312 are urged in the direction reaching the auxiliary brake mode from the brake release mode in the normal state.

Therefore, for example, in running uphill by switching to the auxiliary brake mode, even when the operating levers 2112, 2312 are operated to the side of the brake release mode against intension of the operator, the operating levers 2112, 2312 are always exerted with the external force in accordance with the urging and therefore, the operating levers 2112, 2312 return again to the auxiliary brake mode. Therefore, rotation of the brake drum 2003 is restricted and reverse running or the like against intension of the operator is avoided.

Further, according to the brake operating apparatus 2100, 2300 shown in the embodiment, the operating levers 2112, 2312 are urged in the direction from the main brake mode to the auxiliary brake mode by way of the brake release mode by constituting a start point by the main brake mode. Further, the brake operating apparatus 2100, 2300 shown in the embodiment are provided with the operation restricting portions 2120, 2320 for restricting operation of the operating levers 2112, 2312 reaching the auxiliary brake mode from the main brake mode by being brought into contact with the operating levers 2112, 2312 in the brake release mode (neutral position).

Therefore, the operating levers 2112, 2312 operated in the direction reaching the auxiliary brake mode from the main brake mode by way of the brake release mode by the external force in accordance with the urging are restricted from operating to the auxiliary brake mode by the contact state by the operation restricting portions 2120, 2320.

Therefore, in operating between the main brake mode and the brake release mode, the operating levers 2112, 2312 are stopped at the brake release mode without reaching the auxiliary brake mode. Therefore, the operator can operate the operating lever 2112 between the main brake mode and the brake release mode without being conscious of erroneous operation to the auxiliary brake mode.

Further, according to the embodiment, there is brought about the state in which the tension operated to the operating cable 2010c and the reaction force produced by being brought into contact with the operation restricting portions 2120, 2320 are operated to the operating levers 2112, 2312 and the operating levers 2112, 2312 are positioned in the brake release mode by the balance between the two forces. Therefore, in setting the neutral positions of the operating levers 2112, 2312, complicated links springs or the like are not needed and a number of parts can be reduced. Therefore, the brake operating apparatus can be fabricated inexpensively.

Further, when the movable range or the neutral position of the operating lever 2015 is changed in accordance with the change in the specification of the brake apparatus 2001, the change can be dealt with by adjusting, for example, play of the operating cable 2015c or the like. Further, the change can also be dealt with by interchanging the operating lever to the operating lever 2112 having the guide pin 2112b at a different position and interchanging the housing to the housing 2110 having the guide groove 2111 having a different shape or the like. In this way, by adjusting play of the operating cable 2015c or interchanging the constituent parts, the change in the specification can easily be dealt with.

Further, the above-described embodiment is strictly an embodiment of the invention and details thereof can pertinently be changed in accordance with various specifications.

For example, although according to the above-described brake operating apparatus 2300 for the boarding person, in order to restrict operation by way of the brake release mode, as a constituent part of the operation restricting portion 2320, portions of the constituent parts of the one way clutch apparatus 2330 are commonly used, this is not necessarily needed and operation of the operating lever 2312 may be restricted only by the stopper 2322.

Further, also with regard to the position of the engaging teeth 2131 which is a constituent part of the one way clutch apparatus 2130, in accordance with the change in the specification of the brake apparatus 2001, the position, the attaching angle or the like can be changed. Further, when the engaging teeth 2131 is fixed to the operating lever 2112 by a screw or the like, by relaxing the screw, the position of the engaging teeth 2131 can easily be changed and the angle can easily be adjusted.

Further, although an explanation has been given of the brake apparatus according to the invention by taking an example of the brake apparatus 2001 for the wheelchair in the above-described embodiment, the brake operating apparatus 2100, 2300 are not limited to the wheelchair but applicable also to a brake for a baby buggy, a bicycle, a carriage, an industrial machine, a motorcycle, or an automobile.

(Third Embodiment)

A brake operating apparatus 3100 shown in a third embodiment is provided with a housing 3110 (support member) fixed to a frame or the like of a wheelchair 3200, and an operating lever 3112 pivotably supported centering on a supporting shaft (not illustrated) provided at the housing 3110.

Further, the operating lever 3112 is connected with an operating wire 3015 extended to a brake apparatus 3001 (inner expanding type brake apparatus) integrated to a wheel and by operating the operating wire 3015 via the operating lever 3112, the brake is devised to apply by pivoting an operating cam of the brake apparatus 3001.

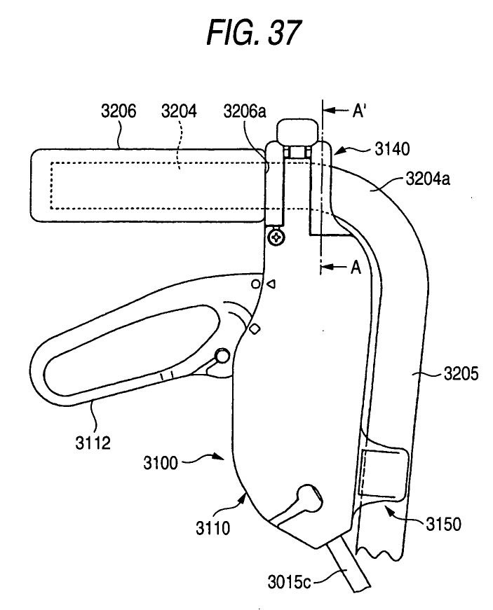

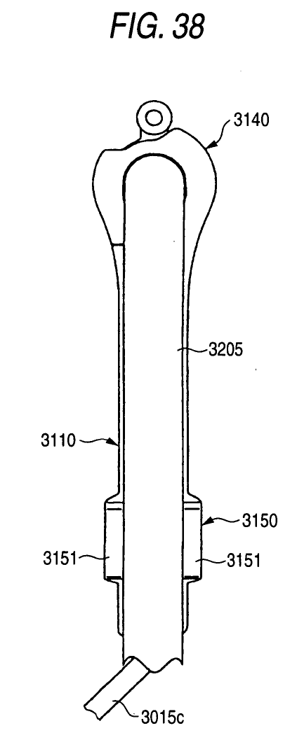

The housing 3110 which is a constituent part of the brake operating apparatus 3100 is formed by a hard synthetic resin material or the like and is provided with a first fixing portion 3140 outwardly fit to a base portion 3204a of a handle 3204 for a helper provided on a back side of seat of the wheelchair 3200, and a second fixing portion 3150 fixed to a vertical frame 3205 rising at the back side of the seat as shown by FIG. 37.

Further, the handle 3204 for a helper is formed by folding to bend an upper portion of the vertical frame 3205 to the back side of the wheelchair 3200.

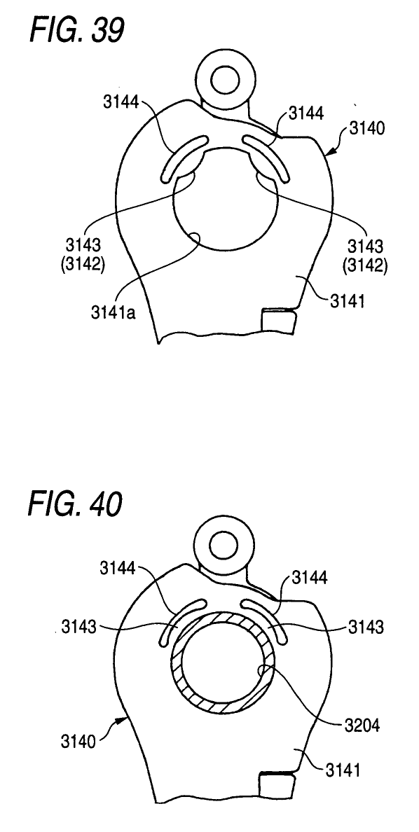

As shown by FIG. 39, the first fixing portion 3140 is provided with a sleeve 3141 having a noncircular through hole formed by a diameter substantially the same as the outer diameter of the handle 3204 and an inner peripheral face 3141a of the sleeve 3141 is provided with a pressing portion 3142 for pressing the inner peripheral face of the sleeve 3141 to the handle 3204 in outwardly fitting to the handle 3204.

Further, according to the embodiment, in setting a shape of the pressing portion 3142, as shown by FIG. 39, a bent portion 3143 expanded from the inner peripheral face of the sleeve 3141 is formed at the inner peripheral face 141a of the sleeve 3141. Further, an air gap 3144 is formed on a back side of the bent portion 3143.

Therefore, in outwardly fitting the sleeve 3141 (first fixing portion) to the handle 3204, as shown by FIG. 40, the bent portion 3143 is more or less permitted to deform by the air gap 3144 and therefore, an operator can comparatively easily press the sleeve 3141 from an end portion of the handle 3204 to a side of the base portion 3204a.

Further, in outwardly fitting the sleeve 3141, the bent portion 3143 is pressed (urged) to the handle 3204 and therefore, by friction with a surface of the handle 3204 in accordance with the pressing, a positional shift of the sleeve 3141 in an axial direction of the handle 3204 and pivoting of the sleeve 3141 in a peripheral direction of the handle 3204 are restrained.

Meanwhile, the second fixing portion 3150 is provided with a pair of pinching pieces 3151 capable of being engaged with the vertical frame 3205.

The pinching piece 3151 is extended in a direction the same as that of the through hole provided at the sleeve 3141. Further, a dimension ensured between one of the pinching pieces 3151 and other of the pinching pieces 3151 is provided with a value substantially equal to a diameter of the vertical frame 3205.

Therefore, when the housing 3110 is inserted to the base portion 3204a of the handle 3204, the vertical frame 3205 is pinched between the pinching pieces 3151 and therefore, rotation of the sleeve 3141 around an axis of the handle 3204, that is, pivoting of the housing 3110 relative to the handle 3204 is restricted by the pinching pieces 3151.

Successively, an explanation will be given of a method of attaching the brake operating apparatus 3100.

First, the operator connects the housing 3110 to the handle 3204 by inserting the sleeve 3141 from the end portion of the handle 3204.

Further, at this occasion, since the inner peripheral face of the sleeve 3141 is formed with the bent portion 3143 as described above, the operator presses the sleeve 3141 to the base portion 3204a of the handle 3204 while applying a pressure to a degree of bending the bent portion to the air gap 3144 on a back side thereof.

Successively, the operator finely adjust an angle of the housing 3110 such that the vertical frame 3205 is disposed between the pinching pieces 3151 and thereafter, presses the sleeve 3141 to the base portion 3204a of the handle 3204 from the state to thereby interpose the vertical frame between the pinching pieces 3151.

Successively, the operator inserts a grip 3206 from the end portion of the handle 3204 and presses the grip 3206 to the base portion 3204a of the handle 3204 until an opening end 3206a of the grip 3206 is brought into contact with an end face of the sleeve 3141.

Further, by coating an adhering agent on an inner peripheral face of the grip 3206 or a surface of the handle 3204, the grip 3206 may be adhered to fix thereto as necessary.

In this way, according to the brake operating apparatus 3100 shown in the embodiment, first, the sleeve 3141 (ring-like connecting portion) provided at the first fixing portion 3140 is inserted from the end portion of the handle 3204 to connect the housing 3110 to the handle 3204.

Successively, the second fixing portion 3150 provided at a position different from that of the sleeve 3141 is locked to the vertical frame 3205 extended in a direction different from that of the handle 3204 via the pinching pieces 3151.

That is, the housing 3110 is connected to the handle 3204 by the sleeve 3141, further, pivoting of the housing 3110 around the axis of the handle 3204 is restricted by the pair of pinching pieces 3151 provided at the second fixing portion 3150.

Further, movement (positional shift) of the sleeve 3141 in the axial direction of the handle 3204 is hampered by the grip 3206 inserted from the end portion of the handle 3204 other than a friction force (resisting force) provided by the bent portion 3143 (pressing portion 3142) provided on the inner peripheral face of the sleeve 3141.

In this way, according to the brake operating apparatus 3100 shown in the embodiment, in fixing the first fixing portion 3140 and the handle 3204, pivoting of the housing 3110 relative to the handle 3204 can be restricted without using a fastening piece of a clamp or the like.

Further, also in the positional shift of the first fixing portion 3140 in the axial direction of the handle 3204, the positional shift can similarly be restricted without using a fastening piece or the like.

That is, in fixing the housing 3110 and the handle 3204 and in fixing the housing 3110 and the vertical frame 3205, a structure required for the fixing can be simplified.

Further, in the integrating operation, by moving the first fixing portion 3140 and the second fixing portion 3150 to predetermined positions, the position of the housing 3110 is determined self-adjustingly and therefore, the operator can fix the housing 3110 to a pertinent location without adjusting the position of the housing 3110.

Further, since it is not necessary to tightly fasten the housing 3100 to the handle 3204 or the like as described above, a comparatively soft material of a resin or the like in which various color variations are present can also be selected. Therefore, a cover for an ornamental use and the housing 3110 can integrally be molded from a resin material and the brake operating apparatus can be fabricated to promote a beautiful outlook thereof and inexpensively.

Further, the above-described embodiment is strictly an embodiment of the invention and details thereof can be changed in accordance with various specifications.

For example, although according to the above-described embodiment, an explanation has been given of the brake operating apparatus 3100 according to the invention by taking an example of the brake apparatus 3001 for the wheelchair 3200, the brake operating apparatus 3100 is applicable not only to the brake of the wheelchair but also a brake of, for example, a baby buggy, a bicycle, a carriage, an industrial machine, a motorcycle, an automobile or the like.

Further, although according to the embodiment, as the brake operating apparatus 3100 for a helper, the brake operating apparatus 3100 is attached to the handle 3204 for a helper extended to the back side of the seat, an attaching position thereof can arbitrarily be changed and the brake operating apparatus 3100 can also be integrated, for example, to a base portion 3208a or the like of an armrest frame at which an armrest frame 3208 extended to a side of the seat of the wheelchair 3200 and a leg portion frame 3210 hung down from the armrest frame 3208 to a front wheel 3209 of the wheelchair 3200 are intersected with each other.

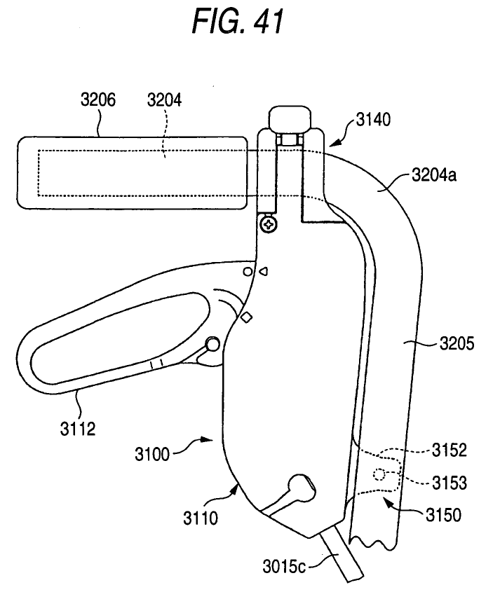

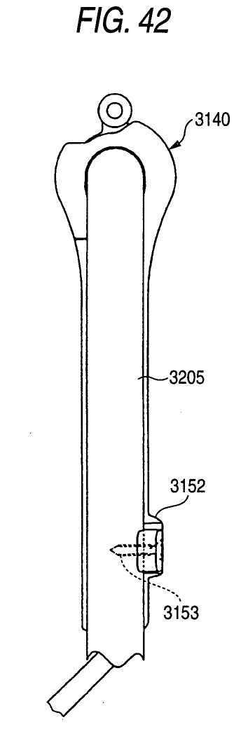

Further, as shown by FIG. 41 and FIG. 42, in place of the pinching pieces 3151, there is also conceivable a constitution in which an extended portion 3152 extended in a peripheral direction of the vertical frame 3205 is formed at the housing 3110 and the extended portion 3152 is fixedly screwed to the vertical frame 3205 by using a screw 3153 or the like.

Further, the screw 3153 used here is only means for fixing the second fixing portion 3150 to the vertical frame 3205 and a screw having a slender diameter is sufficient therefor. Further, in place of the screw 3153, a bolt or the like having a slender diameter may be used.

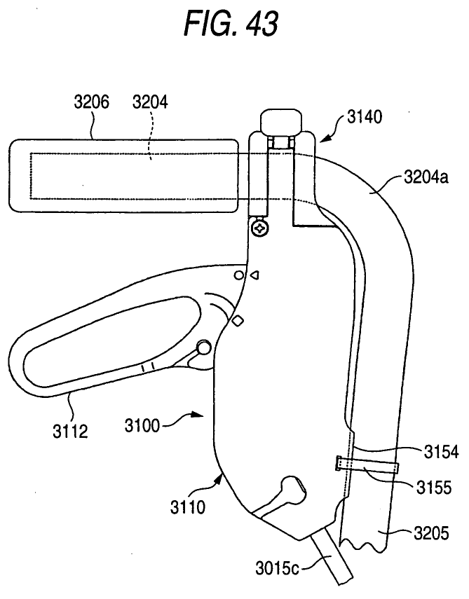

Further, as shown by FIG. 43, the second fixing portion 3150 may be formed with a recess portion 3154 along an outer periphery of the vertical frame 3205 and the housing 3110 may be bound to the vertical frame 3205 by using a binding strip 3155 or the like such that the recess portion 3154 is always brought into contact with the outer peripheral face of the vertical frame 3205.

Further, also in the constitution, the reaction force of the operating lever 3112 operated to the housing 3110 is dispersed to the fist fixing portion 3140 and the second fixing portion 3150 and therefore, a sufficient fixing strength can be ensured even by a comparatively soft member of the binding strip 3155 or the like.

1. A brake operating apparatus of a brake apparatus, for restricting rotation of a rotating member, comprising:
an operating lever, operably supported in a movable range including a first position permitting the rotating member to rotate regularly and rotate reversely, and a second position restricting only one of regular rotation and reverse rotation of the rotating member, and urged from the first position to the second position in a normal state; and
an operation restricting portion contactable with the operating lever at the first position for restricting a movement of the operating lever reaching the second position.

2. The brake operating apparatus according to claim 1 further comprising:
a supporting member for operably supporting the operating lever,
a contact member contactable with the operating lever; and
an urging member for urging the contact member to the operating lever,
wherein the operating lever comprises an operation restricting member for contacting with the contact member at the first position to restrict movement of the operating lever reaching the second position.

3. The brake operating apparatus according to claim 1, wherein the movable range further includes a third position restricting both of regular rotation and reverse rotation of the rotating member, and
wherein the operating lever is urged in a direction reaching the second position from the third position by way of the first position in the normal state.

4. The brake operating apparatus according to claim 3,
wherein the brake apparatus comprises:
a main brake member for restricting regular rotation and reverse rotation of the rotating member;
an auxiliary brake member for restricting reverse rotation of the rotating member by being self-locked to contact with the rotating member in reversely rotating the rotating member; and
an operating cam for individually operating the main brake member and the auxiliary brake member according to an operation to the operating lever,
wherein, in operating the operating lever from the first position to the third position, the operating cam is operated to press the main brake member to the rotating member by a press force in accordance with an operating amount thereof,
wherein, when the operating lever is operated to the second position, the operating cam is operated to bring only the auxiliary brake member into contact with the rotating member.

5. The brake operating apparatus according to claim 3 further comprising:
a one way clutch apparatus for permitting only to operate the operating lever from the first position to the third position; and
a release apparatus for releasing an operation by the one way clutch from being restricted.

6. A brake operating apparatus of a brake apparatus, for restricting rotation of a rotating member, comprising:
an operating lever for operating a brake force in accordance with an operating amount thereof to the rotating member when the operating lever is operated in a predetermined direction;
a one way clutch apparatus for permitting only to operate the operating lever operated in the predetermined direction and holding the operating lever at a position in accordance with the operating amount;
a release apparatus for releasing an operation of the operating lever by the one way clutch apparatus from being restricted; and
an operating portion, for operating the release apparatus, provided at an arm extended to a position capable of being gripped along with the operating lever in operating the operating lever to operate in the predetermined direction.

7. The brake operating apparatus according to claim 6, wherein the operating portion provided at the arm is provided to be able to operate in a peripheral direction of the arm.

8. A brake operating apparatus of a brake apparatus, for restricting rotation of a rotating member, comprising:
a first and a second operating levers for operating the brake apparatus for individually restricting rotation of the rotating member,
wherein the first and the second operating levers are supported to be able to operate in a movable range including a first position permitting regular rotation and reverse rotation of the rotating member, a second position restricting only either one of regular rotation and reverse rotation of the rotating member, and a third position restricting both of regular rotation and reverse rotation of the rotating member, and the operating levers are urged in a direction reaching the second position in a normal state.

9. The brake operating apparatus according to claim 8, wherein the first and the second operating levers respectively constitute a start point by the third position and are urged in a direction reaching the second position from the third position by way of the first position, further comprising:
an operation restricting portion for restricting an operation of the operating lever reaching the second position from the third position at the first position by being brought into contact with the operating lever at the first position.

10. The brake operating apparatus according to claim 8,
wherein the brake apparatus comprises:
a main brake member for restricting regular rotation and reverse rotation of the rotating member;
an auxiliary brake member for restricting reverse rotation of the rotating member by being self-locked to contact with the rotating member in reversely rotating the rotating member; and
an operating cam for individually operating the main brake member and the auxiliary brake member according to an operation to one of the first and second operating levers,
wherein, in operating the one of the first and the second operating levers from the first position to the third position, the operating cam is operated to press the main brake member to the rotating member by a press force in accordance with an operating amount thereof, and
wherein, when the one of first and second operating levers is operated to the second position, the operating cam is operated to bring only the auxiliary brake member into contact with the rotating member.

11. The brake operating apparatus according to claim 8 further comprising:
a one way clutch apparatus permitting only an operation of one of the first and the second operating levers directed from the first position to the third position; and
a release apparatus for releasing the operation of the one way clutch apparatus from being restricted.

12. The brake operating apparatus according to claim 8 further comprising:
a connecting member, for connecting the brake apparatus and the first and the second operating levers and transmitting an operation to the first and the second operating levers to the brake apparatus, including a first connecting member extended from the brake apparatus and a second connecting member connecting the first connecting member to the first and the second operating levers; and
a pulling amount adjusting apparatus between the first connecting member and the second connecting member for making the second connecting member remote from the first connecting member in operating a predetermined load to the second connecting member.

13. A brake operating apparatus comprising:
an operating lever for operating a brake apparatus provided at a vehicle; and
a supporting member for pivotably supporting the operating lever, wherein the operating lever is provided to the vehicle via the supporting member;
wherein the supporting member comprises;
a ring-like connecting portion outwardly fit to a first frame extended in a predetermined direction of the vehicle; and
a pivoting movement restricting portion, contactable with a second frame extended in a direction different from a direction of the first frame, for restricting pivoting movement of the supporting member around an axis of the first frame.

14. The brake operating apparatus according to claim 13, wherein the ring-like connecting portion includes:
a sleeve having an inner diameter capable of being outwardly fit to the first frame, and
a pressing portion, provided at an inner peripheral face of the sleeve, for pressing the inner peripheral face of the sleeve to the first frame in outwardly fitting to the first frame.

15. The brake operating apparatus according to claim 14, wherein the pressing portion includes:
a bent portion provided to expand from the inner peripheral face of the sleeve, and
an air gap formed on a back side of the bent portion for permitting to deform the bent portion to an outer side of the sleeve in outwardly fitting to the first frame.

16. The brake operating apparatus according to claim 13 further comprising:
a pair of pinching pieces, for engaging with the second frame, formed in the pivoting movement restricting portion.

17. The brake operating apparatus according to claim 13, wherein the first frame comprises a handle extended from the second frame.

18. An attaching method to attach a brake operating apparatus to a vehicle, wherein a brake operating apparatus includes an operating lever for operating a brake apparatus and a supporting member pivotably supporting the operating lever to a vehicle, comprising:
a step of forming a connecting portion constituting a ring-like shape in the supporting member, and inserting the connecting portion from an end portion of a first frame extended in a predetermined direction of the vehicle; and
a step of fixing the supporting member to a second frame extended in a direction different from a direction of the first frame at a position different from a position of the connecting portion after inserting the connecting portion.

19. The attaching method according to claim 18, wherein the first frame comprises a handle extended from the second frame, and
wherein, after inserting the connecting portion to the first frame, a grip of the handle is inserted from the end portion of the first frame to fix the grip to the handle.
